(19) United States
(12) Patent Application Publication
(10) Pub. No.: US 2026/0029853 A1
(43) Pub. Date: Jan. 29, 2026

(54) COMPUTER SYSTEM, METHOD, AND PROGRAM

(71) Applicants: Sony Interactive Entertainment Inc., Tokyo (JP); Sony Interactive Entertainment LLC, San Mateo, CA (US)

(72) Inventors: Yoshimi Nakada, Tokyo (JP); Daisuke Kawamura, Foster City, CA (US); Takahisa Kurose, Kanagawa (JP); Hideki Yanagisawa, Kanagawa (JP)

(73) Assignees: Sony Interactive Entertainment Inc., Tokyo (JP); Sony Interactive Entertainment LLC, 2207 Bridgepointe Pkwy, CA (US)

(21) Appl. No.: 19/269,255

(22) Filed: Jul. 15, 2025

Related U.S. Application Data
(60) Provisional application No. 63/676,491, filed on Jul. 29, 2024.

(51) Int. Cl. G06F 3/01; G06T 7/73; G06V 40/10; G06V 40/20

(52) U.S. Cl. CPC G06F 3/017; G06T 7/73; G06V 40/10; G06V 40/28; G06T 2207/30196

(57) ABSTRACT

Provided is a computer system for control based on input from a user, the computer system including at least one memory for storing a program code and at least one processor for executing an operation in accordance with in which the operation includes acquiring information associated with an imaged field including the user, recognizing a pose formed by a body of the user in a real space and relevant information associated with a feature of the pose, on the basis of the information, and executing a command linked with a combination of the pose and the relevant information beforehand.

### BACKGROUND

The present disclosure relates to a computer system, a method, and a program.

In related art, there has been known a technology which gives input in accordance with movement of a user body without using an operation device such as a controller (e.g., see product introduction pages of Leap Motion Controller (Ultraleap Limited), https://www.ultraleap.com/product/leap-motion-controller/(hereinafter, referred to as Non Patent Document 1)).

Non Patent Document 1 discloses an input device capable of performing contactless device operations in accordance with movement of user fingers put over a controller disposed on a desk.

### SUMMARY

However, the technology described in Non Patent Document 1 requires a user to put the fingers over the controller, and therefore limits the position of the controller and the movement of the user.

In view of the above circumstances, it is desirable to provide a computer system, a method, and a program for enabling a user to perform intuitive operations with improved usability for the user at the time of performing input in accordance with movement of the body of the user.

Provided according to an embodiment of the present disclosure is a computer system for control based on input from a user. The computer system includes at least one memory for storing a program code and at least one processor for executing an operation in accordance with the program code. The operation includes acquiring information associated with an imaged field including the user, recognizing a pose formed by a body of the user in a real space and relevant information associated with a feature of the pose, on the basis of the information, and executing a command linked with a combination of the pose and the relevant information beforehand.

Provided according to another embodiment of the present disclosure is a method for control based on input from a user. The method includes, by an operation executed with use of a processor in accordance with a program code stored in a memory, acquiring information associated with an imaged field including the user, recognizing a pose formed by a body of the user in a real space and relevant information associated with a feature of the pose, on the basis of the information, and executing a command linked with a combination of the pose and the relevant information beforehand.

Provided according to still another embodiment of the present disclosure is a program for control based on input from a user. An operation executed with use of a processor in accordance with the program includes acquiring information associated with an imaged field including the user, recognizing a pose formed by a body of the user in a real space and relevant information associated with a feature of the pose, on the basis of the information, and executing a command linked with a combination of the pose and the relevant information beforehand.

### BRIEF DESCRIPTION OF THE DRAWINGS

FIG. 1 is a diagram illustrating an example of a system according to one embodiment of the present disclosure;

FIG. 2 is a diagram illustrating a device configuration of the system;

FIG. 3A is a functional block diagram of a processor of a computer;

FIG. 3B is a functional block diagram of a processor of a camera unit;

FIG. 4 is a diagram illustrating an example of information acquired by the camera unit;

FIG. 5 is a flowchart illustrating an overall flow of a process executed by the system;

FIG. 6A is a diagram explaining a gesture in a specific example;

FIG. 6B is a diagram explaining a gesture in a different specific example;

FIG. 7A is a diagram explaining a gesture in a different specific example;

FIG. 7B is a diagram explaining a gesture in a different specific example;

FIG. 8A is a diagram explaining a gesture in a different specific example;

FIG. 8B is a diagram explaining a gesture in a different specific example;

FIG. 9A is a diagram explaining a gesture in a different specific example;

FIG. 9B is a diagram explaining a gesture in a different specific example;

FIG. 10A is a diagram explaining a gesture in a different specific example;

FIG. 10B is a diagram explaining a gesture in a different specific example;

FIG. 11A is a diagram explaining a gesture in a different specific example;

FIG. 11B is a diagram explaining a gesture in a different specific example;

FIG. 12 is a flowchart illustrating an example of a flow for execution of a command;

FIG. 13 is a flowchart illustrating a flow of a different process executed by the system.

FIG. 14A is a diagram explaining an input mode in a specific example;

FIG. 14B is a diagram explaining an input mode in a different specific example;

FIG. 15A is a diagram explaining an input mode in a different specific example;

FIG. 15B is a diagram explaining an input mode in a different specific example;

FIG. 16A is a diagram explaining an input mode in a different specific example;

FIG. 16B is a diagram explaining an input mode in a different specific example;

FIG. 16C is a diagram explaining an input mode in a different specific example;

FIG. 17A is a diagram explaining an input mode in a different specific example;

FIG. 17B is a diagram explaining an input mode in a different specific example;

FIG. 18A is a diagram explaining an input mode in a different specific example;

FIG. 18B is a diagram explaining an input mode in a different specific example;

FIG. 19 is a diagram explaining an input mode in a different specific example;

FIG. 20A is a diagram explaining an input mode in a different specific example;

FIG. 20B is a diagram explaining an input mode in a different specific example;

FIG. 21 is a diagram explaining an input mode in a different specific example;

FIG. 22A is a diagram explaining an input mode in a different specific example;

FIG. 22B is a diagram explaining an input mode in a different specific example;

FIG. 23A is a diagram explaining an input mode in a different specific example;

FIG. 23B is a diagram explaining an input mode in a different specific example;

FIG. 24A is a diagram explaining an input mode in a different specific example;

FIG. 24B is a diagram explaining an input mode in a different specific example;

FIG. 25 is a diagram illustrating the system in a different example; and

FIG. 26 is a diagram illustrating a different device configuration of the system.

### DETAILED DESCRIPTION OF THE PREFERRED EMBODIMENTS

Several embodiments according to the present disclosure will hereinafter be described in detail with reference to the accompanying drawings. Note that constituent elements having substantially identical functional configurations in the present description and the drawings will be given identical reference symbols to omit repetitive explanation.

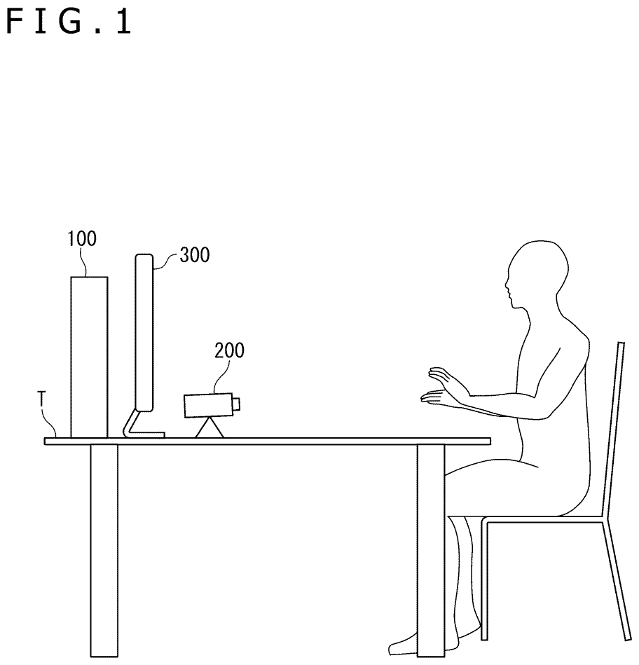

FIG. 1 is a diagram illustrating an example of a system according to one embodiment of the present disclosure. The system of the example illustrated in the figure includes a computer 100, a camera unit 200, and a display device 300. For example, the computer 100 is a game console, a personal computer (PC), or a server device connected to a network.

The camera unit 200 acquires information associated with a field to be imaged (imaged field) including a user, and transmits the acquired information to the computer 100.

The camera unit 200 functions as an operation device which acquires information associated with the imaged field including the user to receive operations from the user in a manner similar to the manner of a controller or the like. It is preferable that the camera unit 200 configured as above be disposed at such a position as to face the user and such a position that at least the upper half of the body of the user is included in the imaged field, for example, at a distance of approximately 1 meter from the user, so as to acquire information associated with the imaged field including the user in a real space. According to the example in FIG. 1, the camera unit 200 is placed on a table T and disposed near the display device 300.

Note that, with regard to the position of the camera unit 200, the computer 100 may display a tutorial or the like on the display device 300, for example, to help the user arrange the camera unit 200 at an appropriate position.

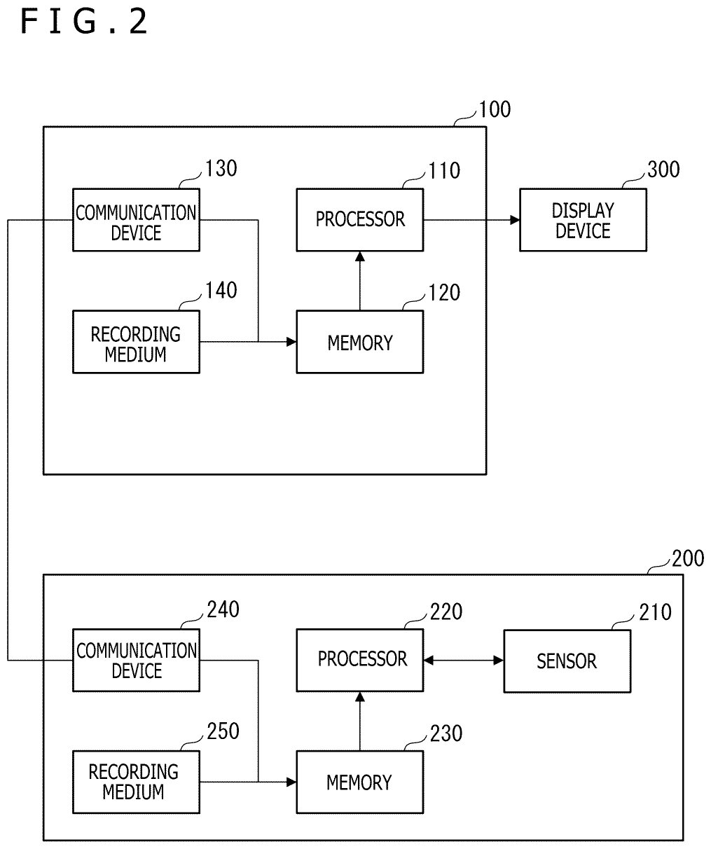

FIG. 2 is a diagram illustrating a device configuration of the system illustrated in FIG. 1. The computer 100 includes a processor 110 and a memory 120. For example, the processor 110 includes a central processing unit (CPU), a digital signal processor (DSP), an application specific integrated circuit (ASIC), a field-programmable gate array (FPGA), and/or other types of processing circuits. Moreover, for example, the memory 120 includes a read only memory (ROM), a random access memory (RAM), a hard disk drive (HDD), and/or other types of storage devices. The processor 110 operates in accordance with program codes stored in the memory 120. The computer 100 further includes a communication device 130 and a recording medium 140. For example, program codes under which the processor 110 operates in a manner described below may be received from an external device via the communication device 130 and stored in the memory 120. Alternatively, the program codes may be loaded from the recording medium 140 into the memory 120. For example, the recording medium 140 includes a removable recording medium such as a semiconductor memory, a magnetic disk, an optical disk, or a magneto-optical disk and a driver for the removable recording medium.

The camera unit 200 includes a sensor 210, a processor 220, a memory 230, a communication device 240, and a recording medium 250. The processor 220, the memory 230, the communication device 240, and the recording medium 250 are similar to the processor 110, the memory 120, the communication device 130, and the recording medium 140 of the computer 100, respectively.

The processor 220 operates in accordance with program codes stored in the memory 230. For example, program codes under which the camera unit 200 operates in a manner described below may be received from an external device via the communication device 240 and stored in the memory 230.

Alternatively, the program codes may be loaded from the recording medium 250 into the memory 230.

The camera unit 200 acquires information associated with the imaged field including the user under control by the processor 220. For example, the sensor 210 may be selected from the following sensors.

A frame-based vision sensor such as a complementary metal oxide semiconductor (CMOS) image sensor or a charge coupled device (CCD) image sensor

An event-based sensor also called an event vision sensor (EVS), an event driven sensor (EDS), or a dynamic vision sensor (DVS) and configured to generate event signals including a time stamp, sensor identification information, and information indicating a polarity of a luminosity change at the time of detection of an intensity change of incident light, more specifically, a luminosity change

A sensor for acquiring distance information, such as a direct time of flight sensor (dToF) and an indirect time of flight (iToF) sensor

Other types of sensors capable of acquiring information associated with the imaged field including the user

Note that the camera unit 200 may include either the single sensor 210 or a plurality of the sensors 210. Moreover, the plurality of sensors 210 may be sensors of the same type or sensors of different types.

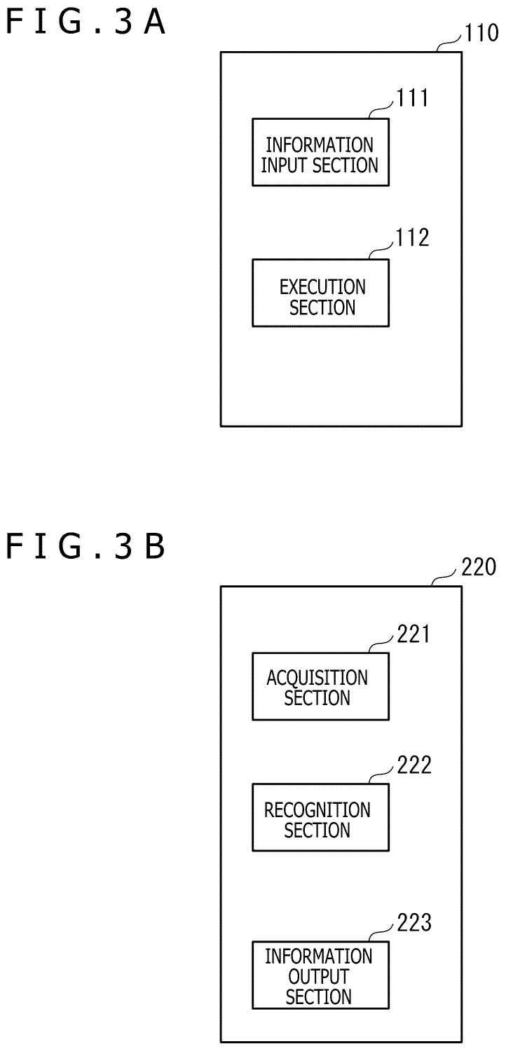

FIG. 3A is a functional block diagram of the processor 110 of the computer 100, while FIG. 3B is a functional block diagram of the processor 220 of the camera unit 200.

As illustrated in FIG. 3A, the processor 110 of the computer 100 includes an information input section 111 and an execution section 112.

The information input section 111 acquires information from the camera unit 200 via the communication device 130 and the like.

The execution section 112 executes a command linked with a combination of a pose and relevant information beforehand, on the basis of information input to the information input section 111.

As illustrated in FIG. 3B, the processor 220 of the camera unit 200 includes an acquisition section 221, a recognition section 222, and an information output section 223.

The acquisition section 221 acquires information associated with the imaged field including the user on the basis of output from the sensor 210. The recognition section 222 recognizes a pose formed by the body of the user in a real space and relevant information associated with a feature of the pose, on the basis of the information acquired by the acquisition section 221.

The information output section 223 outputs information indicating recognition result obtained by the recognition section 222 to the computer 100 via the communication device 240 and the like.

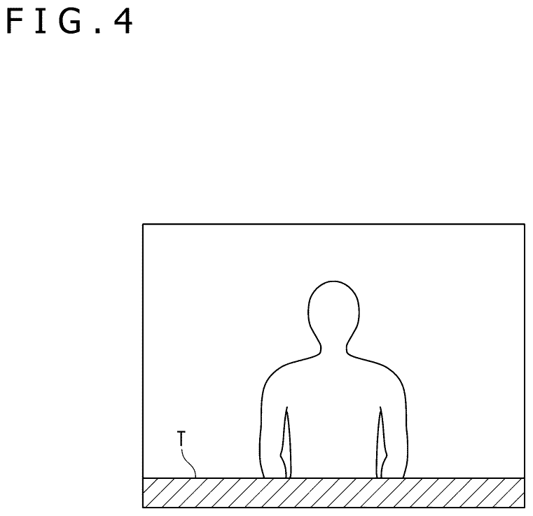

FIG. 4 is a diagram illustrating an example of information acquired by the camera unit 200. As described above, the camera unit 200 is disposed at such a position as to face the user. Accordingly, information acquired by the camera unit 200 includes information associated with a region which includes the upper half of the body of the user and the table T as illustrated in the example in FIG. 4.

For example, the display device 300 includes a monitor such as a liquid crystal display (LCD) and an organic electroluminescent (EL) display, and displays a display image in accordance with information received from the computer 100, to present this image to the user. Moreover, the display device 300 displays a user interface (UI) for receiving input from the user, in accordance with information received from the computer 100. Calibration between the real space and a space on the UI is carried out beforehand by a known method.

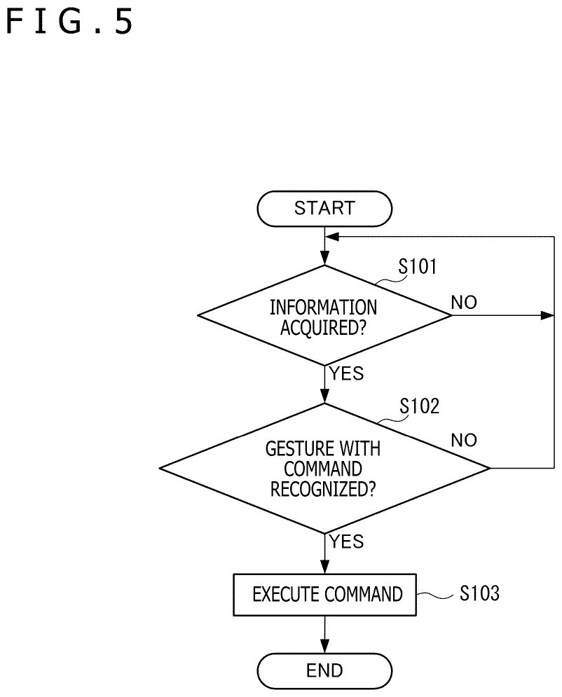

FIG. 5 is a flowchart illustrating an overall flow of a process executed by the system illustrated in FIGS. 1 to 3B. According to the example illustrated in the figure, the processor 220 of the camera unit 200 first determines whether or not information has been acquired by the sensor 210 (step S101). Subsequently, the processor 220 of the camera unit 200 determines whether or not a combination of a pose and relevant information which is one of examples of a combination of a pose and relevant information described later and is linked with a command has been recognized (step S102). If the processor 220 determines that a combination of a pose and relevant information linked with a command has been recognized (step S102: YES), the processor 110 of the computer 100 executes this command (step S103).

According to the present embodiment, the camera unit 200 recognizes a pose formed by the body of the user in the real space and relevant information associated with a feature of the pose. Here, the pose includes both a stationary pose and a moving pose.

Meanwhile, the relevant information includes information indicating a movement or a change of a pose formed by the body of the user described above, information indicating a position of a pose in the imaged field, and the like.

More specifically, the relevant information includes the following information, for example.

A relative positional relation between a position of a pose and a position of a predetermined portion present in the imaged field other than the pose

A relative positional relation between a position of a pose and a position of a predetermined portion included in the body of the user other than the pose

A relative positional relation between a position of a pose and an object present in the imaged field other than the user

A combination of a pose and relevant information will hereinafter be referred to as a “gesture.” In other words, a gesture is expressed by a combination of a pose and relevant information.

The processor 220 of the camera unit 200 recognizes gestures including a stationary pose and a moving pose by using a known posture estimation (pose estimation) technology or the like. For example, the processor 220 calculates positions on the basis of a plurality of joints of a person as feature points by using machine learning, deep learning, or other methods. Thereafter, the processor 220 recognizes a gesture on the basis of a relative relation between the calculated positions. Various known technologies are available for the specific method such as machine learning and deep learning, and therefore, these technologies will not be detailed.

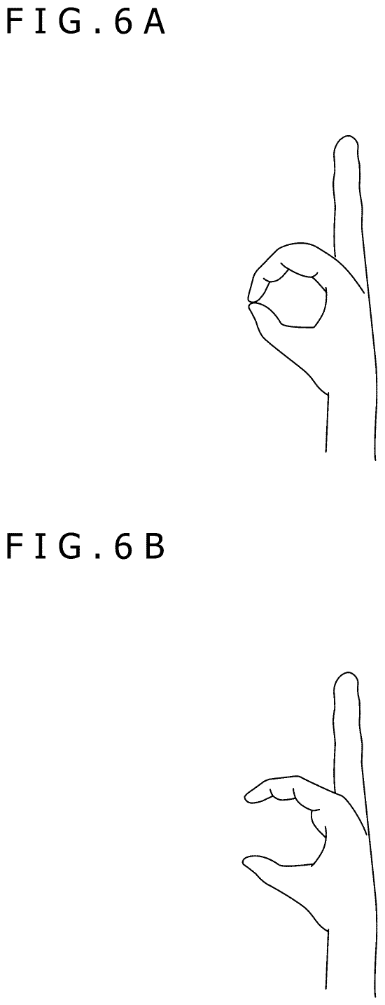

FIGS. 6A to 11B are diagrams each illustrating and explaining a gesture as a specific example of the gestures described above. Note that each of FIGS. 6A to 11B is a diagram for explaining a gesture (a combination of a pose and relevant information), and has an angle of view different from an angle of view of information acquired by the camera unit 200.

FIG. 6A illustrates a pose formed by the tips of the thumb and the index finger of the right hand being brought into contact with each other and the three fingers, i.e., the middle finger, the ring finger, and the little finger, being extended. FIG. 6B illustrates a pose formed by the tips of the thumb and the index finger of the right hand being changed from the state illustrated in FIG. 6A to be separated from each other. The processor 220 may recognize a series of movements to form the pose in FIG. 6A or the pose in FIG. 6B as a gesture, a series of movements from the pose in FIG. 6A to the pose in FIG. 6B (hereinafter referred to as “pinch-out”) as a gesture, or a series of movements from the pose in FIG. 6B to the pose in FIG. 6A (hereinafter referred to as “pinch-in”) as a gesture.

For example, the processor 220 recognizes the example of the gesture illustrated in FIG. 6A, on the basis of the following condition.

Concerning the shape of the gesture, the processor 220 recognizes the example of the pose and the relevant information illustrated in FIG. 6A, in a case where the distance between the tip of the thumb and the tip of the index finger is a predetermined threshold or shorter and the three fingers, i.e., the little finger, the middle finger, and the ring finger, are extended upward.

Moreover, for increasing reliability and accuracy of the recognition, the processor 220 may invalidate the recognition as misrecognition or occurrence of occlusion in a case where the right hand is hidden by the left hand or a case of overlap between two circles that are formed by the left hand and the right hand and that each have a diameter corresponding to a length between the tip of the middle finger and the wrist, for example.

For example, the processor 220 recognizes the example of the gesture illustrated in FIG. 6B, on the basis of the following condition.

Concerning the shape of the gesture, the processor 220 recognizes the gesture illustrated in FIG. 6B, in a case where the distance between the tip of the thumb and the tip of the index finger is a predetermined threshold or shorter, the three fingertips of the middle finger, the ring finger, and the little finger are present above the respective bases in the vertical direction of the space (hereinafter referred to as “above”), and the tip of the index finger is present below the tips of the three fingers, i.e., the middle finger, the ring finger, and the little finger, in the vertical direction of the space (hereinafter referred to as “below”).

Moreover, for increasing reliability and accuracy of the recognition, conditions similar to the conditions described above with reference to FIG. 6A may be set.

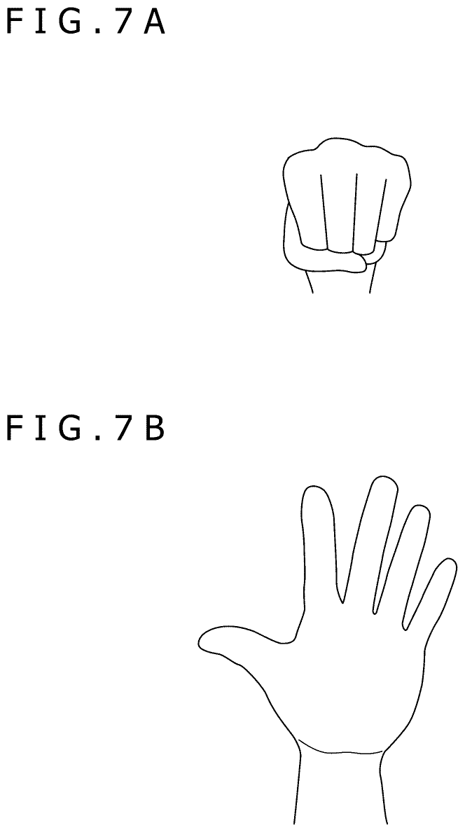

FIG. 7A illustrates a pose formed by all of the fingers of the right hand being bent and making a fist, while FIG. 7B illustrates a pose formed by all of the fingers of the right hand being opened and extended. The processor 220 may recognize the pose in FIG. 7A or the pose in FIG. 7B as a gesture, a series of movements from the pose in FIG. 7A to the pose in FIG. 7B as a gesture, or a series of movement from the pose in FIG. 7B to the pose in FIG. 7A as a gesture.

For example, the processor 220 recognizes the example of the gesture illustrated in FIG. 7A, on the basis of the following condition.

Concerning the shape of the gesture, the processor 220 recognizes the example of the gesture illustrated in FIG. 7A, i.e., a gesture which is what is generally called “rock” of rock-paper-scissors, in a case where each of the joints of the tips of the respective fingers other than the thumb are present below the first joint, the tip of the middle finger is present above the wrist, and the distance between the base of the middle finger and the wrist is a threshold or longer.

Moreover, for increasing reliability and accuracy of the recognition, the processor 220 may invalidate the recognition as misrecognition or occurrence of occlusion in a case where the fingers are present below the wrist, a case where the fingers are in contact with the table T, a case where the wrist is present below the elbow, a case where the right hand is hidden by the left hand, or a case of overlap between two circles that are formed by the left hand and the right hand and that each have a diameter corresponding to a length between the tip of the middle finger and the wrist, for example.

For example, the processor 220 recognizes the example of the gesture illustrated in FIG. 7B, on the basis of the following condition.

Concerning the shape of the gesture, the processor 220 recognizes the example of the gesture illustrated in FIG. 7B, i.e., a gesture which is what is generally called “paper” of rock-paper-scissors, in a case where the joint closer to the tip in the joints of each of the fingers other than the thumb is located at an upper position and the distance between the base of the middle finger and the wrist is a threshold or longer.

Moreover, for increasing reliability and accuracy of the recognition, conditions similar to the conditions described above with reference to FIG. 7A may be set.

While FIGS. 6A and 6B and FIGS. 7A and 7B illustrate examples of the gesture including the pose formed by shapes of the fingers of one hand, a gesture including a pose formed by shapes of the fingers of both hands may be adopted.

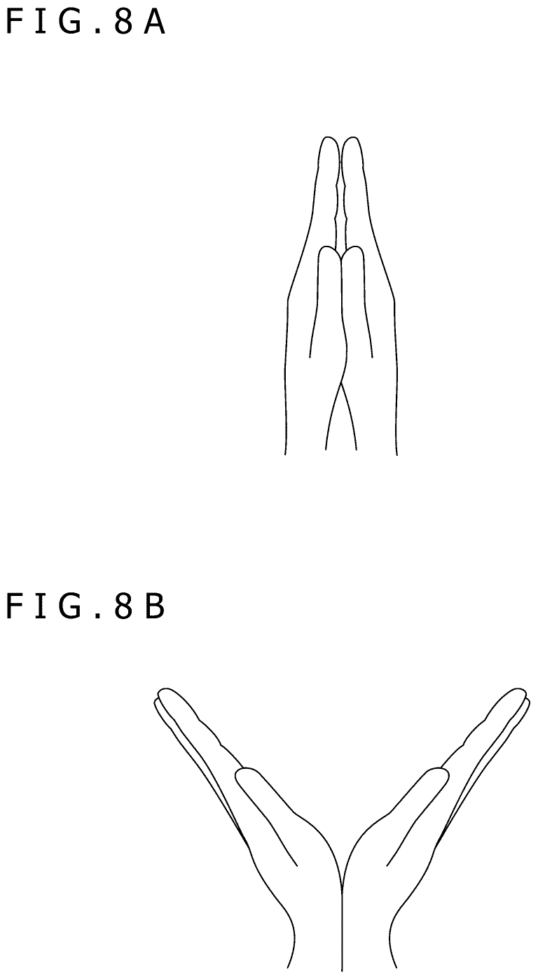

For example, FIG. 8A illustrates a pose formed by the palms of both hands being put together, while FIG. 8B illustrates a pose formed by the fingers of both of the hands being changed from in the state illustrated in FIG. 8A, the fingers of one hand and the fingers of the other hand being separated from each other. The processor 220 may recognize the pose in FIG. 8A or the pose in FIG. 8B as a gesture, a series of movements from the pose in FIG. 8A to the pose in FIG. 8B as a gesture, or a series of movement from the pose in FIG. 8B to the pose in FIG. 8A as a gesture.

Moreover, the processor 220 may recognize a relative positional relation between a position of a pose and a portion of the body of the user other than the pose as relevant information.

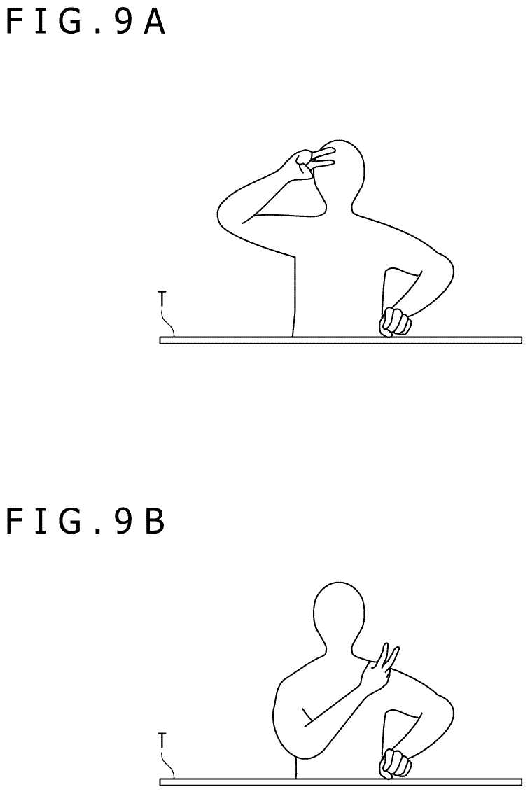

For example, FIG. 9A illustrates a state where what is generally called a V sign formed by the index finger and the middle finger of the right hand being extended is disposed near the head of the user, while FIG. 9B illustrates a state where a similar V sign is disposed near the left shoulder of the user. The processor 220 may recognize the state in FIG. 9A or the state in FIG. 9B as a gesture, a series of movements from the state in FIG. 9A to the state in FIG. 9B as a gesture, or a series of movement from the state in FIG. 9B to the state in FIG. 9A as a gesture.

Note that, while each of FIGS. 9A and 9B illustrates the example of the V sign pose formed by the right hand, other poses may be adopted, and a pose formed by both hands may also be adopted. Moreover, FIG. 9A illustrates the example of the relevant information based on the relative positional relation between the pose formed by the fingers of the user and the head of the user, while FIG. 9B illustrates the example of the relevant information based on the relative positional relation between the pose formed by the fingers of the user and the shoulder of the user. However, a relative positional relation between the pose and a portion of the body of the user other than the head and the shoulder may be recognized as relevant information.

Further, a relative positional relation between a position of a pose and a position of a predetermined portion present in the imaged field other than the pose may be recognized as relevant information. For example, a relative positional relation between a position of a pose and a position of an object, such as a natural object and an artificial object (furniture, building, ornament), present in the imaged field may be recognized as relevant information.

In addition, the processor 220 may recognize a relative positional relation between a position of a pose and an object other than the user as relevant information.

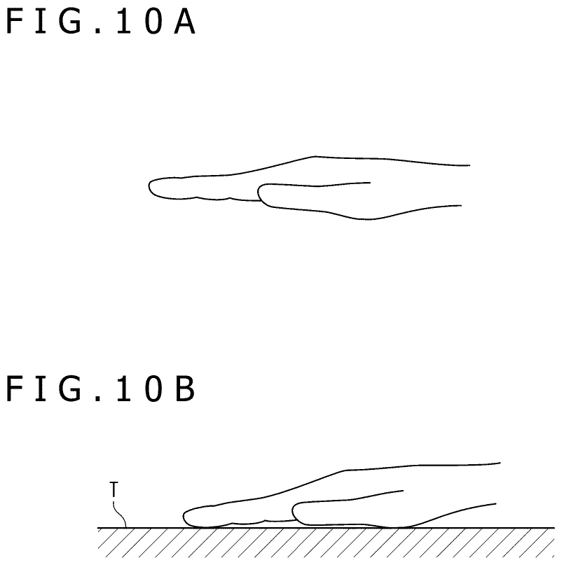

For example, FIG. 10A illustrates a pose formed by the palm of the right hand facing downward, while FIG. 10B illustrates a pose formed by the palm being brought into contact with the table T while maintaining the pose explained with reference to FIG. 10A. The processor 220 may recognize the pose in FIG. 10A or the pose in FIG. 10B as a gesture, a series of movements from the pose in FIG. 10A to the pose in FIG. 10B as a gesture, or a series of movement from the pose in FIG. 10B to the pose in FIG. 10A as a gesture.

For example, the processor 220 recognizes the example of the gesture illustrated in FIG. 10A, on the basis of the following condition.

Concerning the shape of the gesture, the processor 220 recognizes the example of the gesture illustrated in FIG. 10A, in a case where the thumb is present on the body center side of the little finger.

Moreover, for increasing reliability and accuracy of the recognition, the processor 220 may invalidate the recognition as misrecognition or occurrence of occlusion in a case where the distance between the thumb and the little finger is shorter than a threshold, a case where the fingers are located horizontally to the camera unit 200, a case where the right hand is hidden by the left hand, a case of overlap between two circles that are formed by the left hand and the right hand and that each have a diameter corresponding to a length between the tip of the middle finger and the wrist, a case where the wrist is present on the body center side of the shoulder, or a case where the fingers are not stationary, for example.

Whether the fingers are located horizontally to the camera unit 200 can be determined on the basis of comparison between a threshold and a relative positional difference between the wrist and each tip of the fingers in a predetermined direction, for example. Moreover, whether or not the fingers are stationary can be determined on the basis of comparison between a threshold and integrated shift distances of the fingers with reference to comparison with a recognition result in previous information, for example.

A series of movements for shifting from the pose in FIG. 10B to the pose in FIG. 10A and then returning to the pose in FIG. 10B, i.e., a series of movements for touching the table T by the fingers, temporarily separating the fingers from the table T, and again touching the table T by the fingers, is a gesture for touching the table T (hereinafter referred to as a “tap”).

For example, the processor 220 recognizes this gesture by detecting the following state transitions.

### Tap Start Waiting State

The state shifts to the following (2) in a case where the tip of the index finger is present below the second joint of the index finger.

### (2) Finger Swing Up Waiting State

The state shifts to the following (3) in a case where the tip of the index finger is present above the second joint of the index finger.

### (3) Finger Swing Down Waiting State

The state shifts to above-mentioned (1) on the basis of recognition of a gesture of a tap in a case where the tip of the index finger is present below the second joint of the index finger.

Note that, in a case where the fingers are not in contact with the table T or in a case where the palm does not face downward in each of the states described above, the state may shift to above-mentioned (1) for a reset.

Note that a series of movements for shifting to the pose in FIG. 10B from the pose in FIG. 10A and then returning to the pose in FIG. 10A, i.e., a series of movements performed for, from the state of the fingers being separated from the table T, touching the table T by the fingers and again separating the fingers from the table T, may be designated as a gesture of a tap, instead of the gesture of the tap described above. Moreover, a series of movements for shifting to the pose in FIG. 10A from the pose in FIG. 10B, i.e., a series of movements performed for separating the fingers from the table T from the state of the fingers touching the table T, may be designated as a gesture of a tap, instead of the gesture of the tap described above.

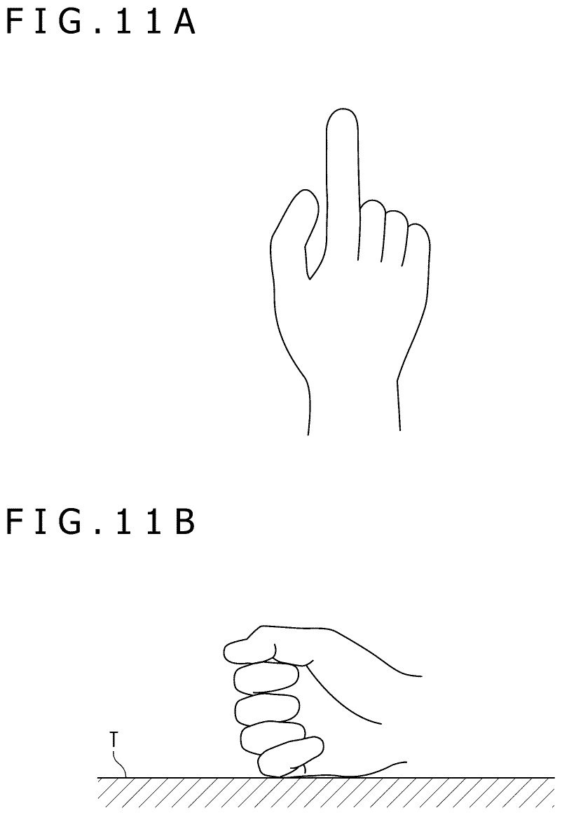

Further, while each of FIGS. 10A and 10B illustrates the example of the gesture for tapping the table T in the pose formed by the palm of the right hand facing downward, a gesture for tapping the table T in a different pose may be adopted, or a gesture for tapping the table T in a pose formed by both hands may also be adopted. For example, as illustrated in FIG. 11A, a gesture for tapping the table T by the tip of the index finger with the index finger in a pose of being extended may be adopted. Moreover, as illustrated in FIG. 11B, a gesture for tapping the table T by the side surface of the palm on the little finger side in a pose formed by all the fingers of the right hand being bent and making a first may be adopted, for example.

As described hereinbefore, the processor 220 of the camera unit 200 recognizes a gesture on the basis of information acquired by the sensor 210. Thereafter, the processor 110 of the computer 100 executes a command linked with the type of the gesture recognized by the camera unit 200, as described above.

The command herein includes a combination of one or more items selected from selection, starting, ending, and determination, and is linked with a type of a gesture beforehand. Examples of this selection include menu selection, object selection, position selection, and color selection using a color pallet or the like.

Corresponding commands are linked with the foregoing gestures, i.e., the combinations of a pose and relevant information. Linkage between the commands and the gestures may be set by the user.

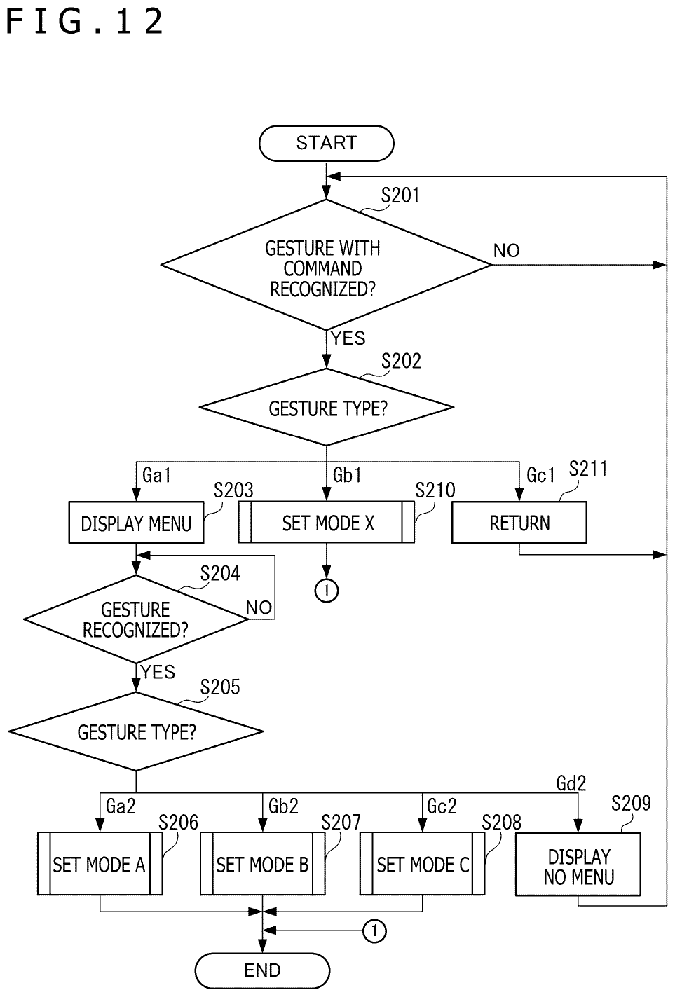

FIG. 12 is a flowchart illustrating an example of a flow associated with execution of a command in the flowchart of the overall flow explained with reference to FIG. 5.

According to the example illustrated in the figure, the processor 220 of the camera unit 200 first determines whether or not a gesture linked with a command has been recognized (step S201).

Subsequently, the processor 110 of the computer 100 determines the type of the recognized gesture (step S202). In a case where the gesture is a gesture Ga1, the flow proceeds to step S203. In a case where the gesture is a gesture Gb1, the flow proceeds to step S210 described below. In a case where the gesture is a gesture Gc1, the flow proceeds to step S211 described below.

In other words, the user is allowed to select and execute a desired command by executing any one of the gestures Ga1, Gb1, and Gc1.

In a case where the gesture Ga1 has been recognized, the processor 110 executes a command for menu selection in steps S203 to S209.

More specifically, the processor 110 displays a menu on the display device 300 (step S203). In other words, a command for menu display is linked with the gesture Ga1. In addition, the displayed menu is a command selection menu. Respective commands are linked with different types of gestures beforehand.

In a state where the menu is displayed, the processor 110 determines whether or not the processor 220 of the camera unit 200 has recognized a gesture (step S204). When determining that a gesture has been recognized (step S204: YES), the processor 110 determines the type of the recognized gesture (step S205). In a case where the gesture is a gesture Ga2, the flow proceeds to step S206. In a case where the gesture is a gesture Gb2, the flow proceeds to step S207 described below. In a case where the gesture is a gesture Gc2, the flow proceeds to step S208 described below. In a case where the gesture is a gesture Gd2, the flow proceeds to step S209 described below.

In other words, the user is allowed to execute a desired command corresponding to the item of the menu by executing any one of the gestures Ga2 to Gd2.

Subsequently, the processor 110 executes a command for menu selection in steps S206 to S209.

More specifically, in a case where the gesture Ga2 has been recognized, the processor 110 executes a command for setting a mode A (step S206), in a case where the gesture Gb2 has been recognized, the processor 110 executes a command for setting a mode B (step S207), and in a case where the gesture Gc2 has been recognized, the processor 110 executes a command for setting a mode C (step S208).

In other words, the command for setting the mode A is linked with the gesture Ga2, the command for setting the mode B is linked with the gesture Gb2, and the command for setting the mode C is linked with the gesture Gc2.

Further, after execution of the command corresponding to any one of steps S206 to S208, the processor 110 ends a series of processes.

Meanwhile, in a case of determination that the gesture Gd2 has been recognized in step S205, the processor 110 executes a command for no menu display on the display device 300 (step S209). In other words, the command for no menu display is linked with the gesture Gd2. Subsequently, the processor 110 returns to step S201.

As apparent from above, the processor 220 executes, in any one of steps S206 to S209, one of the different commands each linked with corresponding gesture, in accordance with the type of the gesture determined in step S205.

Note that, according to the example described above, the command for menu display is linked with the gesture Ga1, and the command for no menu display is linked with the gesture Gd2. In a case where commands to be linked are symmetrical commands such as “menu display” and “no menu display,” corresponding gestures may also be symmetrical gestures, making it possible to help the user perform intuitive operations.

For example, the symmetrical gestures may be gestures including poses formed by symmetrical shapes of the fingers, such as a gesture including a pose formed by the palm facing upward and stationary and a gesture including a pose formed by the palm facing downward and stationary. Moreover, for example, the symmetrical gestures may be gestures including symmetrical movements of the fingers, such as a gesture including a movement from a state of all the fingers being bent and making a first to a pose formed by the fingers being opened and extended and a gesture including a movement from a state of all the fingers being opened and extended to a pose formed by all the fingers being bent and making a fist. Further, the symmetrical gestures may be gestures including poses formed by symmetric shapes and symmetric movements of the fingers.

In a case where the gesture Gb1 has been recognized in step S202, the processor 110 executes a command for setting a mode X (step S210). In other words, the command for setting the mode X is linked with the gesture Gb1.

Meanwhile, in a case where the gesture Gc1 has been recognized in step S202, the processor 110 executes a command for returning to step S201 (step S211). In other words, the command for returning to step S201 is linked with the gesture Gc1.

As apparent from above, the processor 110 executes, in any one of step S203, S210, and S211, one of the different commands each linked with the corresponding gesture, in accordance with the type of the gesture recognized in step S202.

Note that FIG. 12 is a flowchart for explaining one example of the types and variations of the commands. Accordingly, needless to say, types of gestures, recognition timing of gestures, types of commands, and the like are not limited to this example, and may include any combinations.

Note that specific gestures may be linked with specific commands. For example, the “return” command presented in step S211 in FIG. 12 by way of example is a command executed in various situations. Accordingly, for example, a specific gesture unlikely to cause misrecognition and easy to remember for the user, such as a gesture of “turning the palm toward the body,” may constantly be linked with the “return” command. This configuration allows the user to execute the “return” command by performing the specific gesture in any situations when desiring to execute the “return” command, making it possible to help the user intuitively perform operations.

Moreover, including the example in FIG. 12, in a case where a plurality of modes are provided, there may be adopted a configuration in which a command to be executed in response to recognition of the specific gesture is varied in accordance with the modes. In other words, different commands corresponding to the modes may be linked with an identical gesture. For example, for the pinch-in gesture described with reference to FIGS. 6A and 6B, a first command may be linked with a first mode, and a second command different from the first command may be linked with a mode different from the first mode.

As described hereinbefore, the processor 220 of the camera unit 200 recognizes a gesture including a pose of the user in the real space on the basis of information associated with the imaged field including the user and acquired by the sensor 210, and the processor 110 of the computer 100 executes a command linked with the type of the gesture beforehand, on the basis of a result of the recognition.

Accordingly, a command can be executed in accordance with movement of the body of the user without using an operation device such as a controller. Particularly, the necessity and the load of holding an operation device such as a controller or attaching this type of device to the body can be eliminated from the user, and the user can perform intuitive operations in a comfortable position, such as a sitting position. Moreover, since linkage between commands and types of gestures is established beforehand, the user can execute a desired command only by performing an easy gesture.

Hence, input corresponding to movement of the body of the user is achievable in accordance with an intuitive operation by the user with improved usability for the user.

Further, the processor 220 of the camera unit 200 recognizes a relative positional relation between a position of a pose formed by the body of the user and a portion of the body of the user other than the pose as relevant information. Accordingly, improvement of gesture recognition accuracy and an increase of gesture variations are achievable.

In addition, the processor 220 of the camera unit 200 recognizes a relative positional relation between a position of a pose formed by the body of the user and an object present in the imaged field other than the user as relevant information. Accordingly, improvement of gesture recognition accuracy and an increase of gesture variations are achievable.

Moreover, the processor 110 of the computer 100 executes a command variable in accordance with modes, in response to recognition of a specific gesture. Accordingly, a gesture easy to perform for the user and a gesture accurately recognizable for the processor 110 can effectively be used.

Further, the processor 110 of the computer 100 executes a command including a combination of one or more items selected from selection, starting, ending, and determination. Accordingly, the user can execute a command corresponding to a purpose or a desire only by performing a certain gesture. For example, the user can successively and complexly execute a command including a plurality of items only by performing one gesture.

Subsequently described will be an example of a mode change in accordance with a recognized gesture at the time of reception of input from the user to a UI displayed on the display device 300, as one example of a command executed in accordance with a recognized gesture.

As described above, the processor 220 of the camera unit 200 obtains a plurality of joints of a person as feature points on the basis of information acquired by the sensor 210. Such feature points are used for recognition of gestures as described above. In addition to this, such feature points are also used for input from the user. For example, positions and shapes of the fingers of the user and also movements of the fingers in the real space may be recognized and mapped in a space on the UI to receive input from the user in a manner similar to the manner of a controller or the like.

In such a case, in general, feature points unlikely to cause misrecognition, such as a feature point of the wrist, for example, are referred to for detection stability considered as an important factor. However, more detailed and intuitive user input is often demanded. In view of this, the processor 220 executes a command for enabling the user to set an input mode, in accordance with a type of a recognized gesture. The input mode herein includes a position of a feature point for reference, an input method, and other items.

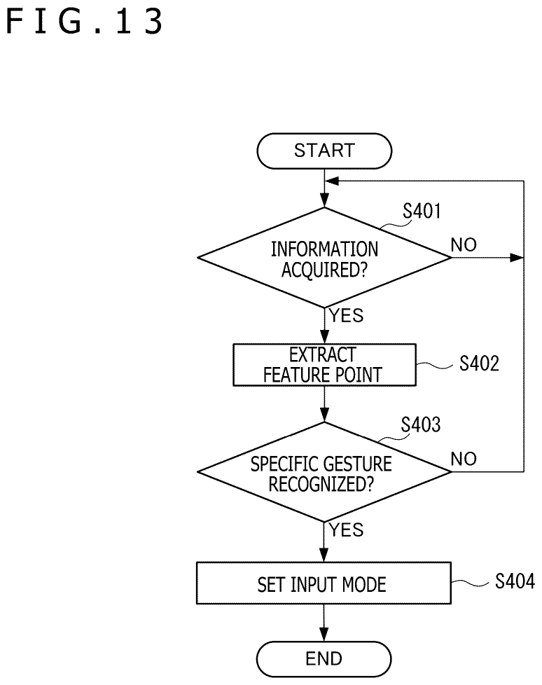

FIG. 13 is a flowchart illustrating a flow of a different process executed by the system illustrated in FIGS. 1 to 3B. According to the example illustrated in the figure, the processor 220 of the camera unit 200 first determines whether or not the sensor 210 has acquired information (step S401), and extracts a feature point on the basis of the acquired information (step S402).

Subsequently, the processor 110 of the computer 100 determines whether or not a gesture linked with a command has been recognized (step S403). In case of determination that a gesture linked with a command has been recognized (step S403: YES), the processor 110 of the computer 100 executes a command for setting an input mode corresponding to the recognized gesture (step S404).

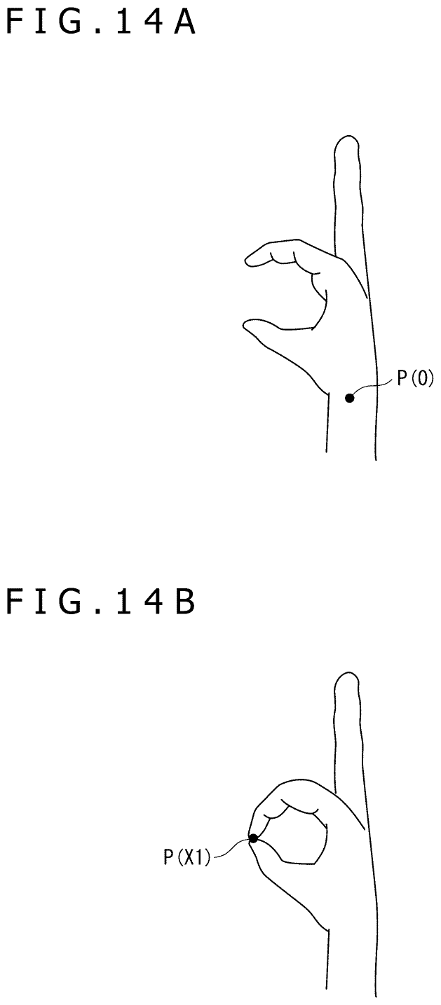

FIGS. 14A to 24B are diagrams each illustrating and explaining an input mode as a specific example of the input mode described above. Note that each of FIGS. 14A to 24B is a diagram for explaining the input mode and has an angle of view different from an angle of view of information acquired by the camera unit 200 as in FIGS. 6A to 11B.

A series of movements performed from a pose in FIG. 14A to a pose in FIG. 14B correspond to a pinch-in gesture as explained with reference to FIGS. 6A and 6B. In a normal input mode, a point P(0) corresponding to a feature point of a wrist portion is referred to as illustrated in FIG. 14A.

When the processor 220 of the camera unit 200 recognizes the pinch-in gesture, the processor 110 of the computer 100 sets an input mode for referring to a point P(X1) corresponding to a point of contact between the tips of the thumb and the index finger as illustrated in FIG. 14B. In other words, the point for reference is shifted to a position closer to distal ends of the fingers of the user.

Moreover, when the processor 220 of the camera unit 200 recognizes a specific gesture, the processor 110 of the computer 100 may shift the position of the feature point for reference to a position at a shorter distance from the sensor 210 of the camera unit 200. The distance from the sensor 210 of the camera unit 200 can be obtained on the basis of information acquired by the camera unit 200. Note that, in a case where the sensor 210 of the camera unit 200 does not have a sensor for acquiring distance information, three-dimensional information may be generated by a plurality of the sensors 210, or by using image analysis or other methods, for example.

In the input mode set in accordance with the pinch-in gesture, the processor 110 receives input in response to a pinch- in gesture and a pinch-out gesture.

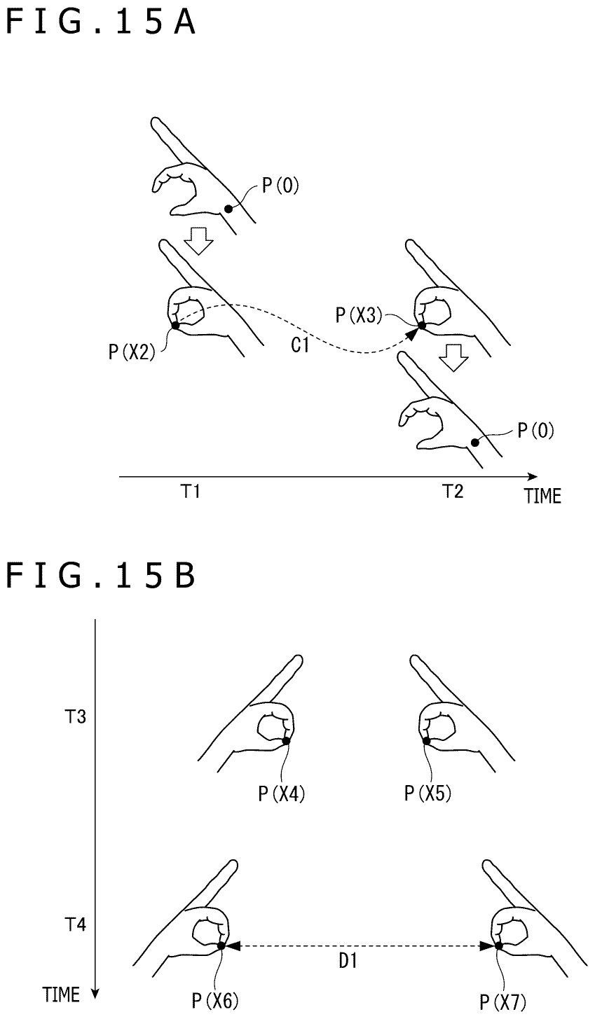

For example, as illustrated in FIG. 15A, in a case where the processor 220 of the camera unit 200 recognizes the pinch-in gesture at a time T1 and the pinch-out gesture at a time T2, the processor 110 of the computer 100 executes a command including the following combination of selection, starting, ending, and determination.

When the processor 220 of the camera unit 200 recognizes the pinch-in gesture at the time T1, the processor 110 of the computer 100 changes the reference point from the point P(0) corresponding to the feature point of the wrist portion, which is similar to the reference point of the normal input mode, to a point P(X2) corresponding to a contact point between the tips of the thumb and the index finger, and starts input of a trajectory from the point P(X2) corresponding to a start point. Thereafter, the processor 110 of the computer 100 tracks the trajectory with reference to the point P(X2) until recognition of the pinch-out gesture by the processor 220 of the camera unit 200. When the processor 220 of the camera unit 200 subsequently recognizes the pinch-out gesture at the time T2, the processor 110 of the computer 100 changes the reference point from a point P(X3) to the point P(0), i.e., the feature point of the wrist portion, which is similar to the reference point in the normal input mode, and ends input of the trajectory at the point P(X3) corresponding to an end point.

The user can input a trajectory C1 from the point P(X2) to the point P(X3) as a free curve by moving the position while maintaining the pose explained with reference to FIG. 13B, after execution of the pinch-in gesture. Note that the input is not limited to a curve and may be a straight line.

A different example will be discussed. When the processor 220 of the camera unit 200 recognizes the pinch-in gesture at the time T1, the processor 110 of the computer 100 changes the reference point from the point P(0) to the point P(X2). The processor 110 then determines an unillustrated object corresponding to the point P(X2) as a target, and starts movement of the object. Thereafter, the processor 110 of the computer 100 tracks a trajectory with reference to the point P(X2) until recognition of the pinch-out gesture by the processor 220 of the camera unit 200, and moves the object in accordance with the trajectory. When the processor 220 of the camera unit 200 subsequently recognizes the pinch-out gesture at the time T2, the processor 110 of the computer 100 changes the reference point from the point P(X3) to the point P(0), and ends movement of the object at the point P(X3) corresponding to an end point.

The user performs the pinch-in gesture corresponding to a desired object to select a target object, and moves the position while maintaining the pose explained with reference to FIG. 13B. In this manner, the user can move the object from the point P(X2) to the point P(X3) along the trajectory C1.

Moreover, for example, in a case where the processor 220 of the camera unit 200 recognizes the pinch-in gesture performed by both of the hands at a time T3 and the pinch-out gesture performed by both of the hands at a time T4 as illustrated in FIG. 15B, the processor 110 of the computer 100 executes a command including the following combination of selection, starting, ending, and determination.

When the processor 220 of the camera unit 200 recognizes the pinch-in gesture performed by both of the hands at the time T3, the processor 110 of the computer 100 changes the reference point to a point P(X4) corresponding to a contact point between the tips of the thumb and the index finger of the left hand and a point P(X5) corresponding to a contact point between the tips of the thumb and the index finger of the right hand, and starts length input. When the processor 220 of the camera unit 200 subsequently recognizes the pinch-out gesture performed by both of the hands at the time T4, the processor 110 of the computer 100 determines, as a start point, a point P(X6) corresponding to a contact point between the tips of the thumb and the index finger of the left hand at the time T4, determines, as an end point, a point P(X7) corresponding to a contact point between the tips of the thumb and the index finger of the right hand at the time T4, calculates a distance D1 between the point P(X6) and the point P(X7), and ends the length input.

After performing the pinch-in gesture by using both of the hands, the user increases or decreases the distance between the left and right hands for distance adjustment while maintaining the pose in FIG. 13B. In this manner, the user can input the distance D1 between the point P(X6) and the point P(X7) as a length.

A different example will be discussed. When the processor 220 of the camera unit 200 recognizes the pinch-in gesture performed by both of the hands at the time T3, the processor 110 of the computer 100 changes the reference point to the point P(X4) and the point P(X5). The processor 110 then determines an unillustrated object corresponding to the point P(X4) and the point P(X5) as a target, and starts enlargement or reduction of the object. Thereafter, the processor 110 of the computer 100 enlarges or reduces the object in accordance with the distance D1 between the point P(X4) and P(X5) with reference to the point P(X4) and the point P(X5) until recognition of the pinch-out gesture by the processor 220 of the camera unit 200. When the processor 220 of the camera unit 200 subsequently recognizes the pinch-out gesture performed by both of the hands at the time T4, the processor 110 of the computer 100 ends enlargement or reduction of the object.

The user performs the pinch-in gesture corresponding to a desired object by using both of the hands, to select a target object, and increases or decreases the distance between the left and right hands for distance adjustment while maintaining the pose explained with reference to FIG. 14B. In this manner, the user can enlarge or reduce the object. Note that the object may be deformed in accordance with the distance D1 instead of enlarging or reducing the object.

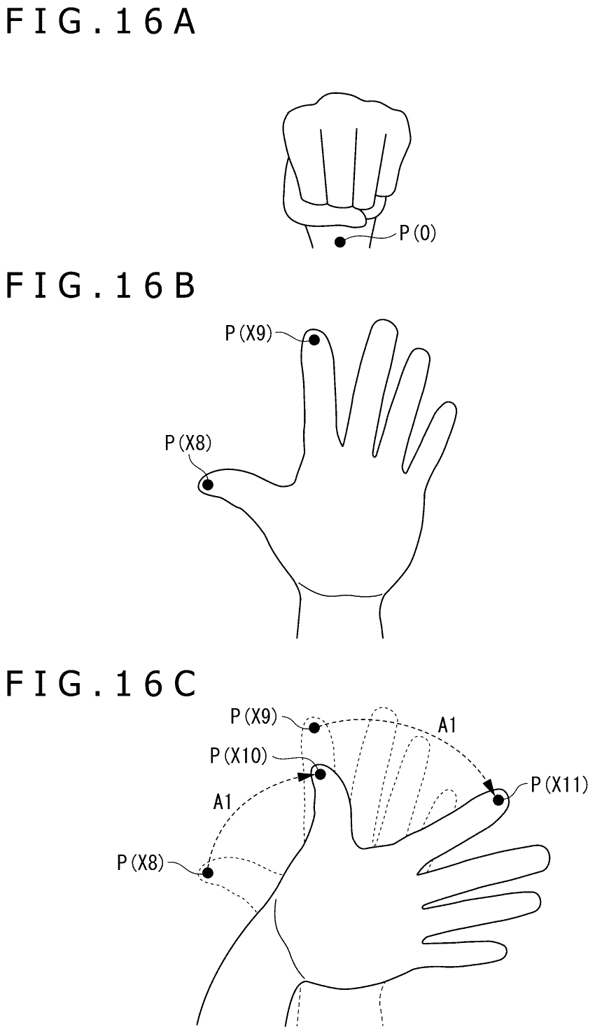

A movement from the pose in FIG. 16A to the pose in FIG. 16B is a gesture for changing the pose formed by all the fingers of the right hand being bent and making a first to the pose formed by all of the fingers being opened and extended as described with reference to FIGS. 7A and 7B. In the normal input mode, the point P(0) corresponding to a feature point of a wrist portion is referred to as illustrated in FIG. 16A.

When the processor 220 of the camera unit 200 recognizes such a gesture, the processor 110 of the computer 100 sets an input mode for referring to a point P(X8) corresponding to a point of the tip of the thumb and a point P(X9) corresponding to a point of the tip of the index finger as illustrated in FIG. 16B. In other words, the position of the point for reference shifts to a position closer to distal ends of the fingers of the user, and the number of reference points increases.

In the input mode set in accordance with the gesture described above, the processor 110 of the computer 100 receives input in accordance with a gesture for rotating the palm.

For example, in a case where the palm is rotated such that the tips of the thumb and the index finger move from the point P(X8) to a point P(X10) and from the point P(X9) to a point P(X11), respectively, as illustrated in FIG. 16C, the processor 110 of the computer 100 executes a command including the following combination of selection, starting, ending, and determination.

When the processor 220 of the camera unit 200 recognizes the gesture for changing from the pose formed by all of the fingers being bent and making a first to the pose formed by all of the fingers being opened and extended, the processor 110 of the computer 100 changes the reference point from the point P(0) corresponding to the feature point of the wrist portion, which is similar to the reference point of the normal input mode, to the point P(X8) corresponding to the tip of the thumb and the point P(X9) corresponding to the point of the tip of the index finger, determines an unillustrated object corresponding to the point P(X8) and the point P(X9) as a target, and starts rotation of the object. Thereafter, the processor 110 of the computer 100 rotates the object with reference to the point P(X8) and the point P(X9) until the processor 220 of the camera unit 200 recognizes a gesture for stopping rotational movement of the fingers. The angle of the rotation of the object may be determined in accordance with an angle A1 corresponding to a rotation angle of the point P(X8) and the point P (X9) around a center point located at the point P(0), or may be determined in accordance with a rotation angle of the point P(X8) and the point P(X9) around any center point other than the point P(0). When the processor 220 of the camera unit 200 subsequently recognizes a gesture for stopping the rotational movement of the fingers, the processor 110 of the computer 100 ends the rotation of the object.

The user performs the gesture for changing the pose formed by all of the fingers being bent and making a first to the pose formed by all of the fingers being opened and extended, in accordance with a desired object, to select a target object, and rotates the palm. In this manner, the user can rotate the object.

Note that the object may be deformed in accordance with the angle A1 instead of rotating the object.

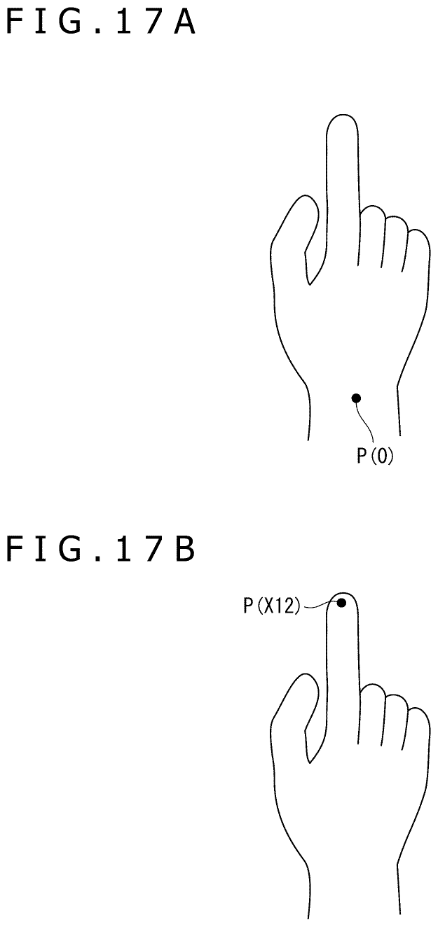

A pose in FIG. 17A is a pose formed by the index finger being extended as explained with reference to FIG. 11A, and used as a gesture for tapping the table T by the tip of the index finger, for example. In the normal input mode, the point P(0) corresponding to a feature point of a wrist portion is referred to as illustrated in FIG. 17A.

When the processor 220 of the camera unit 200 recognizes the gesture for tapping the table T by the tip of the index finger, the processor 110 of the computer 100 sets an input mode for referring to a point P(X12) corresponding to a point of the tip of the index finger as illustrated in FIG. 17B.

In the input mode set in accordance with such a gesture, the processor 110 of the computer 100 receives input in accordance with a gesture performed after tapping.

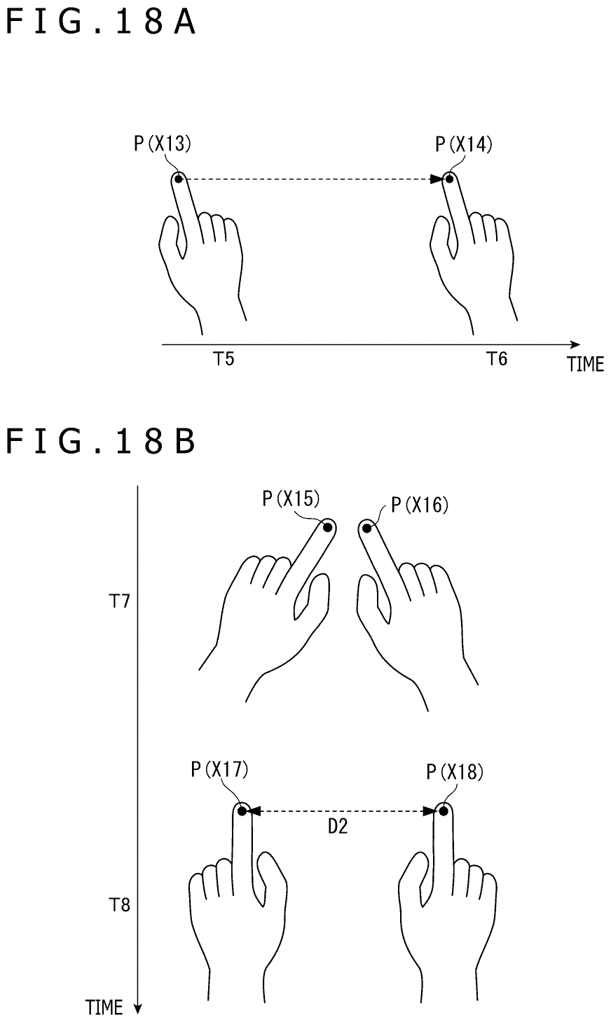

For example, in a case where the processor 220 of the camera unit 200 recognizes the gesture for tapping by the index finger at a time T5 as illustrated in FIG. 18A and recognizes, after sliding of the index finger, a gesture for stopping sliding of the index finger at a time T6, the processor 110 of the computer 100 executes a command including the following combination of selection, starting, ending, and determination.

When the processor 220 of the camera unit 200 recognizes the gesture for tapping by the index finger at the time T5, the processor 110 of the computer 100 changes the reference point to a point P(X13) corresponding to a point of the tip of the index finger, and starts slider input from the point P(X13) corresponding to a start point. Thereafter, the processor 110 of the computer 100 performs slider input in accordance with the position of the point P(X13) with reference to the point P(X13) until recognition of the gesture for stopping sliding of the index finger by the processor 220 of the camera unit 200. When the processor 220 of the camera unit 200 subsequently recognizes the gesture for stopping sliding of the index finger at the time T6, the processor 110 of the computer 100 ends the slider input at an end point located at a point P(X14) corresponding to the tip of the index finger at the time T6, i.e., a slide position of sliding by the user.

The user performs the gesture for tapping by the index finger, and then slides the index finger. In this manner, the user can achieve the slider input. Note that it is preferable that the direction of the slider input be limited to a predetermined direction, such as a left-right direction in the example of FIG. 18A, to avoid misrecognition and maloperation.

Moreover, a free curved line and a straight line may be input in a manner similar to the manner of the example in FIG. 14A, with the point P(X13) being designated as a start point and the point P(X14) being designated as an end point.

Further, for example, in a case where the processor 220 of the camera unit 200 recognizes a gesture for tapping by the index fingers of both of the hands at a time T7 and recognizes, after sliding of the index fingers, a gesture for stopping sliding of the index fingers of both of the hands at a time T8 as illustrated in FIG. 18B, the processor 110 of the computer 100 executes a command in a manner similar to the manner performed for the pinch-in and pinch-out gestures illustrated in the example of FIG. 14B.

Specifically, when the processor 220 of the camera unit 200 recognizes the gesture for tapping by the index fingers of both of the hands at the time T7, the processor 110 of the computer 100 changes the reference point to a point P(X15) corresponding to a point of the tip of the index finger of the left hand and to a point P(X16) corresponding to a point of the tip of the index finger of the right hand, and starts length input. When the processor 220 of the camera unit 200 subsequently recognizes a gesture for stopping sliding of the index fingers of both of the hands at the time T8, the processor 110 of the computer 100 determines a point P(X17) corresponding to the tip of the index finger of the left hand at the time T8 as a start point, determines a point P(X18) corresponding to the tip of the index finger of the right hand as an end point, calculates a distance D2 between the point P(X17) and the point P(X18), and ends the length input.

After performing the tapping gesture by using the index fingers of both of the hands, the user increases or decreases the distance between the index fingers for distance adjustment by sliding the index finger or fingers of one or both of the hands. In this manner, the user can input the distance D2 between the point P(X17) and the point P(X18) as a length.

A different example will be discussed. When the processor 220 of the camera unit 200 recognizes the gesture for tapping by the index fingers of both of the hands at the time T7, the processor 110 of the computer 100 changes the reference point to the point P(X15) and the point P(X16), determines an unillustrated object corresponding to the point P(X15) and the point P(X16) as a target, and starts enlargement or reduction of the object. Thereafter, the processor 110 of the computer 100 enlarges or reduces the object in accordance with the distance D2 between the point P(X15) and the point P(X16) with reference to the point P(X15) and the point P(X16) until a stop of sliding of the index fingers of both of the hands. When the processor 220 of the camera unit 200 subsequently recognizes the gesture for stopping sliding of the index fingers of both of the hands at the time T8, the processor 110 of the computer 100 ends enlargement or reduction of the object.

The user performs tapping by the index fingers of both of the bands in accordance with a desired object to select a target object, and increases or decreases the distance between the index fingers for distance adjustment by sliding the index fingers of both of the hands. In this manner, the user can enlarge or reduce the object. Note that the object may be deformed in accordance with the distance D2 instead of enlarging or reducing the object.

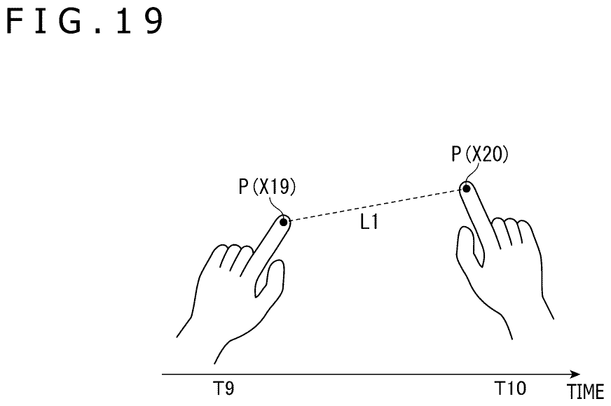

Moreover, for example, in a case where the processor 220 of the camera unit 200 recognizes a gesture for tapping by the index finger of the left hand at a time T9 and recognizes a gesture for tapping by the index finger of the right hand at a time T10 as illustrated in FIG. 19, the processor 110 of the computer 100 executes a command including the following combination of selection, starting, ending, and determination.

When the processor 220 of the camera unit 200 recognizes the gesture for tapping by the index finger of the left hand at the time T9, the processor 110 of the computer 100 changes the reference point to a point P(X19) corresponding to a point of the tip of the index finger of the left hand, and determines the point P(X19) as a start point. When the processor 220 of the camera unit 200 subsequently recognizes the gesture for tapping by the index finger of the right hand at the time T10, the processor 110 of the computer 100 changes the reference point to a point P(X20) corresponding to a point of the tip of the index finger of the right hand, determines the point P(X20) as an end point, and draws a straight line L1 between the point P(X19) and the point P(X20).

The user can draw the straight line L1 between end points located at the point P(19X) and the point P(20X), by performing the gesture for tapping with use of the index finger of the left hand and then performing the gesture for tapping with use of the index finger of the right hand. Alternatively, instead of drawing the straight line L1, the user may draw a circle having a diameter corresponding to the straight line L1, or a different type of figure on the basis of the point P(X19) and the point P(X20).

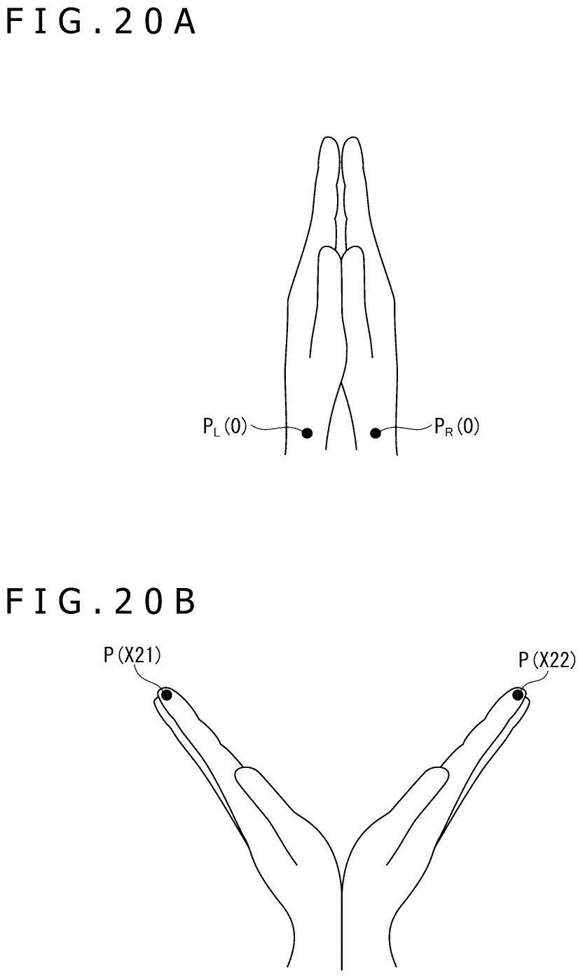

A movement from a pose in FIG. 20A to a pose in FIG. 20B is a gesture for changing a pose formed by the palms of both of the hands being put together to a pose formed by the fingers of one hand and the fingers of the other hand being separated from each other as described with reference to FIGS. 8A and 8B. In a normal input mode, a point P_{L}(0) and a point P_{R}(0) corresponding to feature points of wrist portions of both of the hands are referred to as illustrated in FIG. 20A.

When the processor 220 of the camera unit 200 recognizes such a gesture, the processor 110 of the computer 100 sets an input mode for referring to a point P(X21) corresponding to a point of the tip of the index finger of the left hand and a point P(X22) corresponding to a point of the tip of the index finger of the right hand as illustrated in FIG. 20B.

In the input mode set in accordance with the gesture described above, the processor 110 of the computer 100 receives input in accordance with the gesture for separating the fingers of the one hand and the fingers of the other hand from each other.

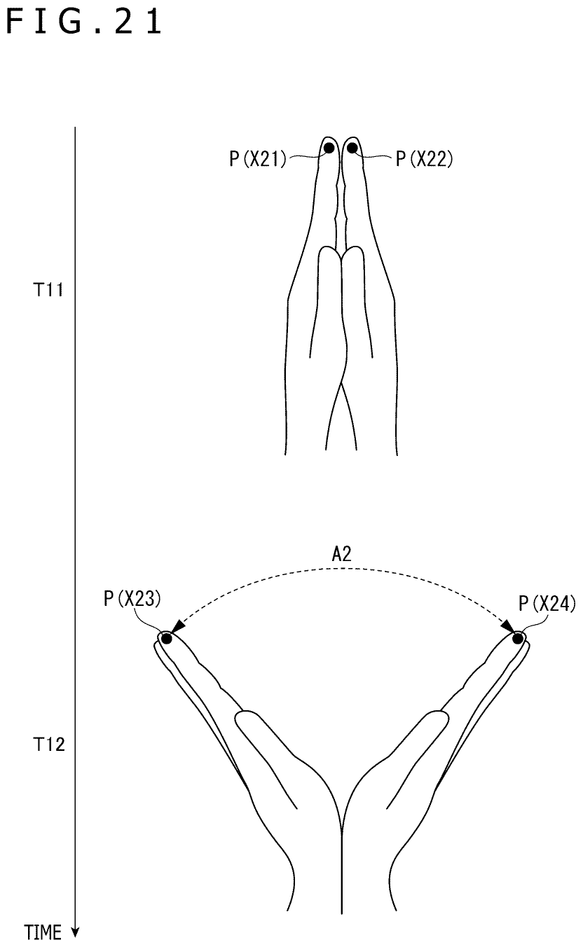

For example, in a case where the processor 220 of the camera unit 200 recognizes a gesture of a pose formed by the palms of both of the hands being put together at a time T11 and recognizes, after an action for separating the fingers of one hand and the fingers of the other hand from each other is performed, a gesture for stopping the fingers of both of the hands at a time T12 as illustrated in FIG. 21, the processor 110 of the computer 100 executes a command including the following combination of selection, starting, ending, and determination.

When the processor 220 of the camera unit 200 recognizes the gesture of a pose formed by the palms of both of the hands being put together at the time T11, the processor 110 of the computer 100 changes the reference point to a point P(X21) and a point P(X22) corresponding to points of the tips of the index fingers of both of the hands, and starts angle input. When the processor 220 of the camera unit 200 subsequently recognizes the gesture for stopping the fingers of both of the hands at the time T12, the processor 110 of the computer 100 calculates an angle A2 on the basis of a point P(X23) and a point P(X24) corresponding to points of the tips of the index fingers of both of the hands at the time T12, and ends angle input. The angle may be determined either on the basis of the points P(0) (the point P_{L}(0) and the point P_{R}(0)) as center points, or on the basis of any points other than the points P(0) as center points. Note that the object may be deformed in accordance with the angle A2 instead of inputting the angle.

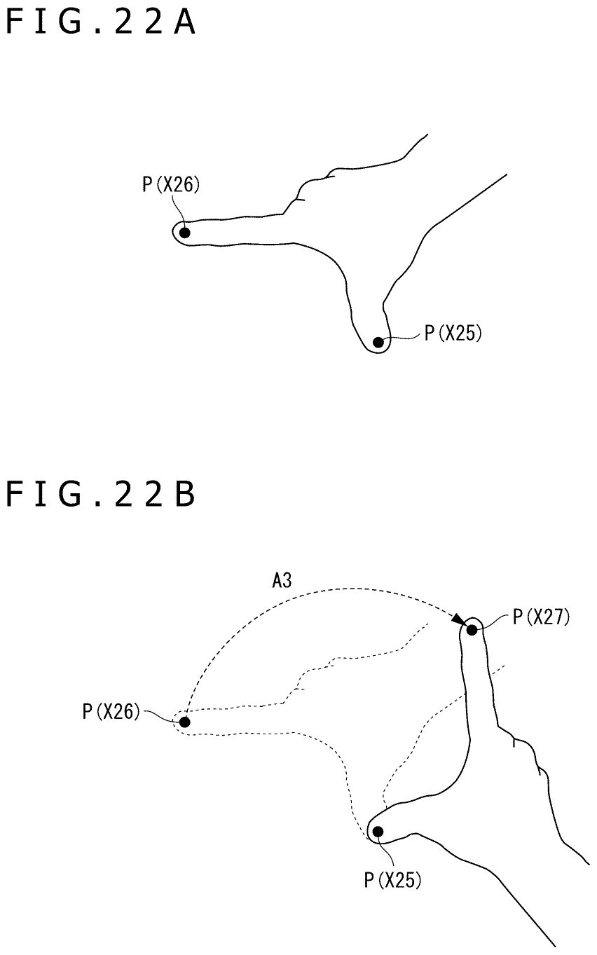

FIG. 22A illustrates a pose formed by the thumb of the right hand being extended downward and the index finger being extended in the direction crossing the thumb at right angles, while FIG. 22B illustrates a pose formed by the index finger being rotated around a center located close to the tip of the thumb from the state illustrated in FIG. 22A.

For example, in a case where the processor 220 of the camera unit 200 recognizes the gesture of the movement from the pose in FIG. 22A to the pose in FIG. 22B, the processor 110 of the computer 100 executes a command including the following combination of selection, starting, ending, and determination.

When the processor 220 of the camera unit 200 recognizes the gesture of the pose illustrated in FIG. 22A, the processor 110 of the computer 100 changes the reference point to a point P(X25) corresponding to a point of the tip of the thumb and a point P(X26) corresponding to a point of the tip of the index finger, determines an unillustrated object corresponding to the point P(X25) and the point P(X26) as a target, and starts rotation of the object. Thereafter, the processor 110 of the computer 100 rotates the object with reference to the point P(X25) and the point P(X26) until the processor 220 of the camera unit 200 recognizes a gesture for stopping the rotational movement of the fingers. An angle A3 is determined as an angle of the rotation of the object on the basis of a center point located at the point P(X25) corresponding to the point of the tip of the thumb. However, in a case where the position of the tip of the thumb deviates from the center point, the angle is determined preferably on the basis of a center point corrected in accordance with a relative positional relation between the point P(X25) corresponding to the point of the tip of the thumb and the point P(X26) or a point P(X27) corresponding to the point of the tip of the index finger. When the processor 220 of the camera unit 200 subsequently recognizes the gesture for stopping the rotational movement of the fingers, the processor 110 of the computer 100 ends the rotation of the object.

The user performs the gesture of the pose illustrated in FIG. 22A, in accordance with a desired object, to select a target object, and rotates the index finger around a position close to the tip of the thumb. In this manner, the user can rotate the object.

Note that the object may be deformed in accordance with the angle A3 instead of rotating the object.

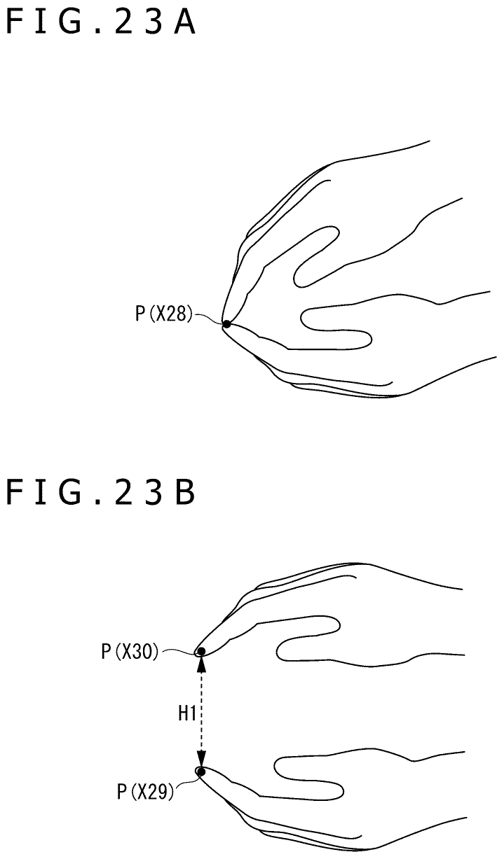

FIG. 23A illustrates a pose formed by the palm of the left hand facing upward, the palm of the right hand being placed at a position facing the palm of the left hand, and the index fingers of both of the hand being brought into contact with each other, while FIG. 23B illustrates a pose formed by the right hand being moved upward from the state illustrated in FIG. 23A to be separated from the left hand.

For example, in a case where the processor 220 of the camera unit 200 recognizes a gesture of the movement from the pose in FIG. 23A to the pose in FIG. 23B, the processor 110 of the computer 100 executes a command including the following combination of selection, starting, ending, and determination.

When the processor 220 of the camera unit 200 recognizes the gesture of the pose illustrated in FIG. 23A, the processor 110 of the computer 100 changes the reference point to a point P(X28) corresponding to a contact point between the tips of the index fingers of both of the hands, and starts height input. When the processor 220 of the camera unit 200 subsequently recognizes a gesture for stopping movement of the fingers, the processor 110 of the computer 100 determines, as end points, a point P(X29) corresponding to a point of the tip of the index finger of the left hand and a point P(X30) corresponding to a point of the tip of the index finger of the right hand at that time, calculates a distance H1 between the point P(X29) and the point P(X30), and ends the height input.

After performing the gesture of the pose illustrated in FIG. 23A, the user breaks the contact between the index fingers and increases or decreases the distance between the left and right hands for distance adjustment. In this manner, the user can input the distance H1 between the point P(X29) and the point P(X30) as a height.

A different example will be discussed. When the processor 220 of the camera unit 200 recognizes the gesture of the pose illustrated in FIG. 23A, the processor 110 of the computer 100 changes the reference point to the point P(X28). The processor 110 then determines an unillustrated object corresponding to the point P(X28) as a target, and starts enlargement or reduction of the object. Thereafter, the processor 110 of the computer 100 enlarges or reduces the object in accordance with the distance H1 between the point P(X29) and the point P(X30) with reference to the point P(X28) (or the tips of the index fingers of both of the hands after separation between the index fingers) until the processor 220 of the camera unit 200 recognizes a gesture for stopping the movement of the fingers. When the processor 220 of the camera unit 200 subsequently recognizes the gesture for stopping the movement of the fingers, the processor 110 of the computer 100 ends the enlargement or reduction of the object.

The user performs the gesture of the pose illustrated in FIG. 23A, in accordance with a desired object, to select a target object, and then increases or decreases the distance between the left and right hands for distance adjustment after separation between the index fingers. In this manner, the user can enlarge or reduce the object. Note that the object may be deformed in accordance with the distance H1 instead of enlarging or reducing the object.

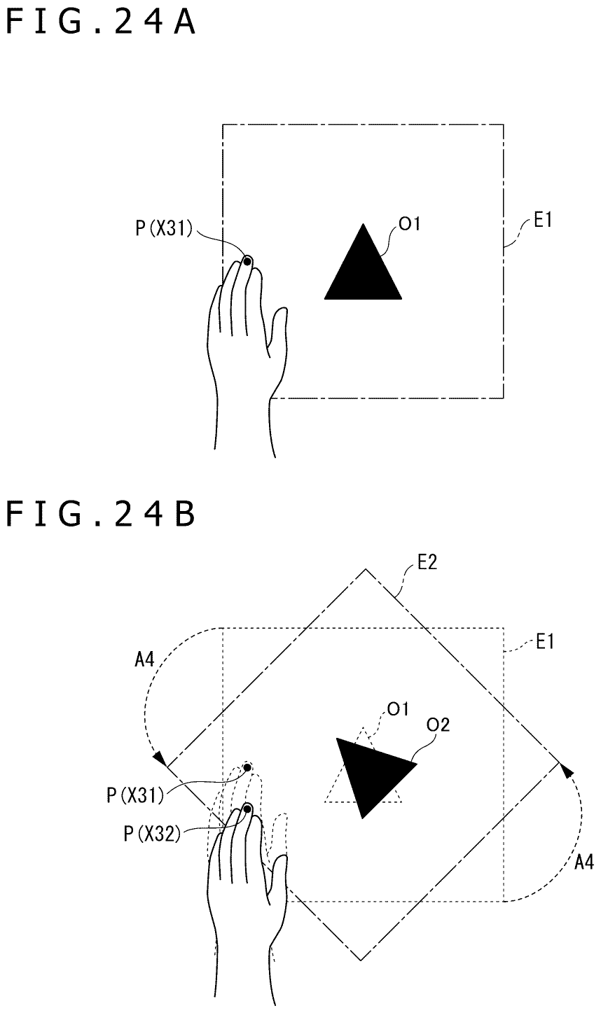

FIG. 24A illustrates a pose for touching the table T by the left hand, while FIG. 24B illustrates a pose for moving the left hand toward the body from the state illustrated in FIG. 24A.

For example, in a case where the processor 220 of the camera unit 200 recognizes a gesture of a movement from the pose in FIG. 24A to the pose in FIG. 24B, the processor 110 of the computer 100 executes a command including the following combination of selection, starting, ending, and determination.

When the processor 220 of the camera unit 200 recognizes the gesture for touching the table T by the left hand as illustrated in FIG. 24A, the processor 110 of the computer 100 changes the reference point to a point P(X31) corresponding to a point of a finger tip of the left hand, and starts rotation of an area. The area herein refers to a predetermined area E1 including the point P(X31) in the space on the UI as illustrated in FIG. 24A. According to the example in FIG. 24A, an object 01 is present within the area E1. The area E1 may be displayed in a visible manner on the UI. Moreover, the area E1 may have a shape other than a rectangular shape, or may be settable by the user.

Thereafter, the processor 110 of the computer 100 rotates the whole of the area E1 with reference to the point P(X31) until the processor 220 of the camera unit 200 recognizes a gesture for stopping the movement of the fingers. The rotation angle of the whole of the area E1 may be determined in accordance with an angle A4 corresponding to a rotation angle of the point P(X31) around a center point located at a specific position (e.g., the center) within the area E1, or may be determined in accordance with a rotation angle of the point P(X31) around any center point outside the area E1. Moreover, the rotation angle of the whole of the area E1 may be determined in accordance with a movement distance of the point P(X31).

When the processor 220 of the camera unit 200 recognizes a gesture for stopping the movement of the fingers, the processor 110 of the computer 100 ends the rotation of the area E1.

The user performs the gesture for touching the table T by the left hand to start rotation of the predetermined area, and moves the left hand toward the body. In this manner, the user can rotate the whole area by an intuitive operation. For example, in a case where the left hand in touch with the table T at the point P(X31) is moved to a point P(X32) and stopped thereat as illustrated in FIG. 24B, the area E1 rotates to a state of an area E2 in accordance with a relative positional relation between the point P(X31) and the point P(X32). As a result, the object O1 rotates to a state of an object O2.

Note that, while the area is rotated anticlockwise in accordance with movement of the left hand toward the body in the example illustrated in FIGS. 24A and 24B, the configuration is not limited to this example. For example, the area may be rotated clockwise by moving the left hand away from the body. In addition, while the area is rotated in the example illustrated in FIGS. 24A and 24B, the configuration is not limited to this example. For example, the area may be moved, enlarged or reduced, or deformed. Further, according to the examples illustrated in FIGS.

14A to 24B, when the processor 220 of the camera unit 200 recognizes a specific gesture, the processor 110 of the computer 100 shifts the position of the reference point to a position closer to the distal ends of the fingers of the user and to a position at a shorter distance from the sensor 210 of the camera unit 200, and increases the number of the reference points. However, the configuration is not limited to these examples.

As described hereinbefore, the processor 220 of the camera unit 200 extracts a plurality of feature points of the body of the user on the basis of information acquired by the sensor 210 and associated with an imaged field including the user, and the processor 110 of the computer 100 receives input from the user on the basis of the extracted feature points. Thereafter, the processor 220 of the camera unit 200 recognizes a gesture including a pose formed by the body of the user in a real space, on the basis of the information acquired by the sensor 210 and associated with the imaged field including the user. When the processor 220 recognizes a specific gesture determined beforehand, the processor 110 of the computer 100 changes a feature point referred to at the time of reception of input from the user.

Hence, more delicate and accurate input is achievable without using an operation device such as a controller at the time of performing input in accordance with movement of the body of the user. Accordingly, intuitive operations are achievable by the user with improved usability for the user.

Moreover, when the processor 220 of the camera unit 200 recognizes a specific gesture, the processor 110 of the computer 100 shifts a position of a feature point referred to at the time of reception of input from the user to a position closer to the distal ends of the fingers of the user. Hence, movement of the body of the user is more accurately detectable. Accordingly, more delicate and accurate input is achievable.

Further, when the processor 220 of the camera unit 200 recognizes a specific gesture, the processor 110 of the computer 100 increases the number of feature points referred to at the time of reception of input from the user. Hence, movement of the body of the user is more accurately detectable on the basis of a larger amount of information for reference. Accordingly, more delicate and accurate input is achievable.

In addition, when the processor 220 of the camera unit 200 recognizes a specific gesture, the processor 110 of the computer 100 shifts a position of a feature point referred to at the time of reception of input from the user to a position at a shorter distance from the sensor used for acquisition of information. The user basically performs gestures for the camera unit 200. Accordingly, accurate and less blurry input is achievable by designating a point located at a shorter distance from the sensor 210 of the camera unit 200 as an attention point.

Note that, while the gestures each including the pose formed by the body of the user have been discussed in the examples illustrated in FIGS. 1A to 24B, the gestures are not limited to these examples. For example, the present disclosure is similarly applicable to gestures including shapes of portions of the user other than the fingers such as the head, facial expressions, states of the eyes, and the like.

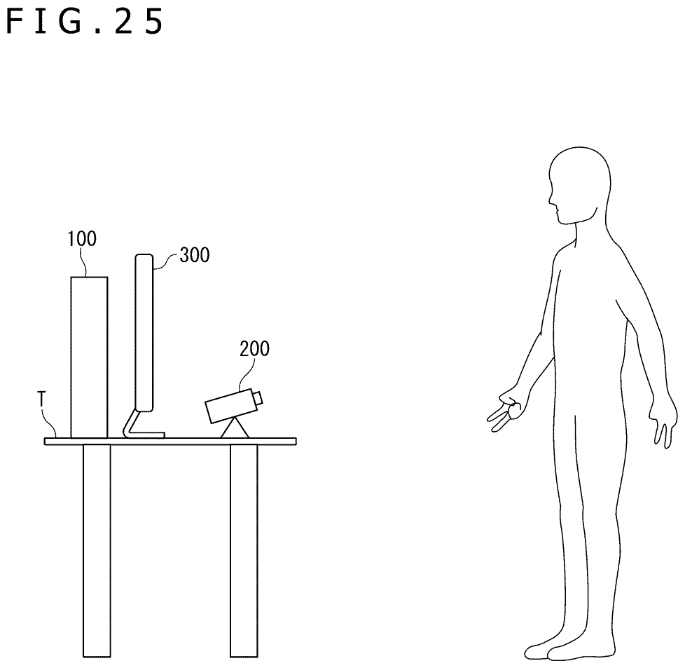

For example, in a case where the present disclosure is applied to a gesture performed using the whole body of the user, it is preferable that the camera unit 200 be disposed at such a position where the whole body of the user is contained in the imaged field as illustrated in FIG. 25. Such positioning enables the sensor 210 of the camera unit 200 to acquire information associated with the imaged field including the whole body of the user.

In addition, commands can be executed in accordance with movement of the whole body of the user on the basis of recognition of the pose formed by the whole body of the user and relevant information associated with the pose.

FIG. 25 illustrates an example of a pose including what are generally called V signs formed by the shapes of the fingers and disposed on both sides of the waist. Also in this example, a relative positional relation between the position of this pose and objects included in the imaged field other than the user is recognizable as relevant information.

Moreover, while the poses each mainly including the

shapes of the fingers of the user have been discussed in the examples illustrated in FIGS. 1A to 24B, these examples are not limitative. For example, the present disclosure is similarly applicable to gestures not including shapes of fingers.

Further, while the gestures each including the gesture performed by the one user have been discussed in the examples illustrated in FIGS. 1A to 24B, the gestures are not limited to these examples. For example, the present disclosure is similarly applicable to gestures performed by a plurality of users.

In addition, while the poses each including the shapes of the fingers of the user as a human have been discussed in the examples illustrated in FIGS. 1A to 24B, the poses are not limited to these examples. For example, the present disclosure is similarly applicable to poses formed by creatures other than humans and objects such as robots, manipulators, and dolls. Moreover, the present disclosure is similarly applicable to poses included in two-dimensional illustrations, images, pictures, and the like.

Note that objects such as robots, manipulators, and dolls may be operated remotely or directly by the user, or may autonomously operate.

Note that the examples illustrated in FIGS. 1A to 24B are such examples where gestures are recognized by the camera unit 200 and commands are executed by the computer 100. However, these examples are not limitative.

For example, a part or all of the processes performed by the recognition section 222 of the processor 220 of the camera unit 200 may be implemented by the processor 110 of the computer 100, or a part or all of the processes performed by the execution section 112 of the processor 110 of the computer 100 may be implemented by the processor 220 of the camera unit 200.

Moreover, for example, a part or all of the processes performed by the processor 110 of the computer 100 and the processor 220 of the camera unit 200 may be implemented by the processor 110 and the processor 220 in cooperation with each other.

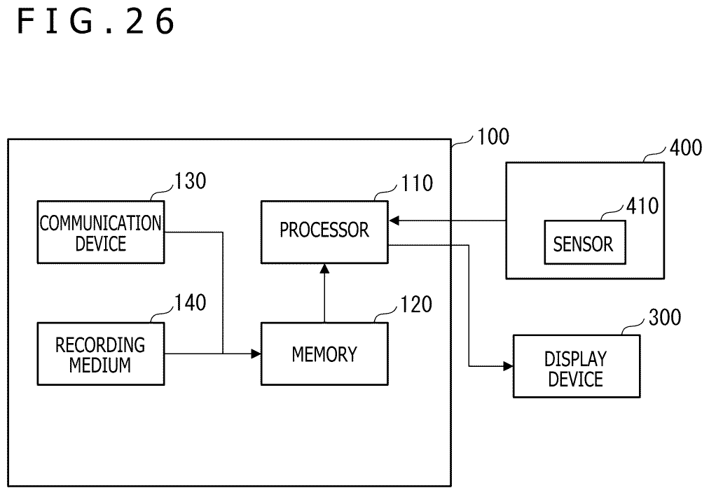

For example, as illustrated in FIG. 26, a camera unit 400 may be employed instead of the camera unit 200. As illustrated in FIG. 26, the camera unit 400 includes only a sensor 410, and outputs information acquired by the sensor 410 to the processor 110 of the computer 100. Thereafter, the processor 110 of the computer 100 recognizes a gesture on the basis of the information acquired by the camera unit 400, and executes a command.

Such a configuration can offer similar advantageous effects even by using the camera unit 400 having a simplified configuration.

While the embodiments according to the present disclosure have been described above in detail with reference to the accompanying drawings, the present disclosure is not limited to these examples. It is apparent that various modified examples or corrected examples within the scope of the technical ideas claimed in the claims can be conceived of by those having ordinary knowledge in the technical field to which the present disclosure belongs. It should be understood that these modified or corrected examples obviously belong to the technical scope of the present disclosure.

### Summary of Present Disclosure

The summary of the present disclosure is described below.

[1] A computer system for control based on input from a user, the computer system including:
at least one memory for storing a program code; and
at least one processor for executing an operation in accordance with the program code,
in which the operation includes
acquiring information associated with an imaged field including the user,
recognizing a pose formed by a body of the user in a real space and relevant information associated with a feature of the pose, on the basis of the information, and
executing a command linked with a combination of the pose and the relevant information beforehand.

[2] The computer system according to [1],
in which the relevant information includes at least either a movement or a change of the pose or a position of the pose in the imaged field.

[3] The computer system according to [1],
in which the relevant information includes a relative positional relation between a position of the pose and a position of a predetermined portion present in the imaged field other than the pose.

[4] The computer system according to [3],
in which the relevant information includes a relative positional relation between a position of the pose and a position of a predetermined portion included in the body of the user other than the pose.

[5] The computer system according to [3],
in which the relevant information includes a relative positional relation between a position of the pose and an object present in the imaged field other than the user.

[6] The computer system according to [1],
in which the executing includes a plurality of modes, and executes the command variable in accordance with the modes, in response to recognition of a combination of a specific type of the pose and the relevant information.

[7] The computer system according to [1],
in which the command includes a combination of one or more items selected from selection, starting, ending, and determination.

[8] The computer system according to [1],
in which the pose includes a shape of a finger of the user.

[9] The computer system according to [1], further including:
a first unit that includes a first memory that is the at least one memory, a first processor that is the at least one processor, and a sensor that acquires information associated with the imaged field; and
a second unit that includes a second memory that is the at least one memory and a second processor that is the at least one processor,
in which the first unit executes at least
acquiring information associated with the imaged field, by using the sensor, and
at least a part of recognizing the pose and the relevant information on the basis of the information.

[10] The computer system according to [1], further including:
a first unit that includes a first memory that is the at least one memory, a first processor that is the at least one processor, and a sensor that acquires information associated with the imaged field; and
a second unit that includes a second memory that is the at least one memory and a second processor that is the at least one processor,
in which the second unit executes
acquiring information associated with the imaged field from the first unit,
recognizing the pose and the relevant information on the basis of the information, and
executing a command linked with a combination of the pose and the relevant information beforehand.

[11] The computer system according to [1], further including:
a first unit that includes a first memory that is the at least one memory, a first processor that is the at least one processor, and a sensor that acquires information associated with the imaged field; and
a second unit that includes a second memory that is the at least one memory and a second processor that is the at least one processor,
in which the first processor and the second processor execute, in cooperation with each other,
acquiring information associated with the imaged field, by using the sensor,
recognizing the pose and the relevant information on the basis of the information, and
executing a command linked with a combination of the pose and the relevant information beforehand.

[12] A method for control based on input from a user, the method including:
by an operation executed with use of a processor in accordance with a program code stored in a memory,
acquiring information associated with an imaged field including the user;
recognizing a pose formed by a body of the user in a real space and relevant information associated with a feature of the pose, on the basis of the information; and
executing a command linked with a combination of the pose and the relevant information beforehand.

[13] A program for control based on input from a user, in which an operation executed with use of a processor in accordance with the program includes
acquiring information associated with an imaged field including the user,
recognizing a pose formed by a body of the user in a real space and relevant information associated with a feature of the pose, on the basis of the information, and
executing a command linked with a combination of the pose and the relevant information beforehand.

1. A computer system for control based on input from a user, the computer system comprising:
at least one memory for storing a program code; and
at least one processor for executing an operation in accordance with the program code, wherein the operation includes
acquiring information associated with an imaged field including the user,
recognizing a pose formed by a body of the user in a real space and relevant information associated with a feature of the pose, on a basis of the information, and
executing a command linked with a combination of the pose and the relevant information beforehand.

2. The computer system according to claim 1, wherein the relevant information includes at least either a movement or a change of the pose or a position of the pose in the imaged field.

3. The computer system according to claim 1, wherein the relevant information includes a relative positional relation between a position of the pose and a position of a predetermined portion present in the imaged field other than the pose.

4. The computer system according to claim 3, wherein the relevant information includes a relative positional relation between a position of the pose and a position of a predetermined portion included in the body of the user other than the pose.

5. The computer system according to claim 3, wherein the relevant information includes a relative positional relation between a position of the pose and an object present in the imaged field other than the user.

6. The computer system according to claim 1, wherein the executing includes a plurality of modes, and executes the command variable in accordance with the modes, in response to recognition of a combination of a specific type of the pose and the relevant information.

7. The computer system according to claim 1, wherein the command includes a combination of one or more items selected from selection, starting, ending, and determination.

8. The computer system according to claim 1, wherein the pose includes a shape of a finger of the user.

9. The computer system according to claim 1, further comprising:
a first unit that includes a first memory that is the at least one memory, a first processor that is the at least one processor, and a sensor that acquires information associated with the imaged field; and
a second unit that includes a second memory that is the at least one memory and a second processor that is the at least one processor,
wherein the first unit executes at least acquiring information associated with the imaged field, by using the sensor, and at least a part of recognizing the pose and the relevant information on a basis of the information.

10. The computer system according to claim 1, further comprising:
a first unit that includes a first memory that is the at least one memory, a first processor that is the at least one processor, and a sensor that acquires information associated with the imaged field; and
a second unit that includes a second memory that is the at least one memory and a second processor that is the at least one processor, wherein the second unit executes
acquiring information associated with the imaged field from the first unit,
recognizing the pose and the relevant information on a basis of the information, and
executing a command linked with a combination of the pose and the relevant information beforehand.

11. The computer system according to claim 1, further comprising:
a first unit that includes a first memory that is the at least one memory, a first processor that is the at least one processor, and a sensor that acquires information associated with the imaged field; and
a second unit that includes a second memory that is the at least one memory and a second processor that is the at least one processor, wherein the first processor and the second processor execute, in cooperation with each other,
acquiring information associated with the imaged field, by using the sensor,
recognizing the pose and the relevant information on a basis of the information, and
executing a command linked with a combination of the pose and the relevant information beforehand.

12. A method for control based on input from a user, the method comprising:
by an operation executed with use of a processor in accordance with a program code stored in a memory,
acquiring information associated with an imaged field including the user;
recognizing a pose formed by a body of the user in a real space and relevant information associated with a feature of the pose, on a basis of the information; and
executing a command linked with a combination of the pose and the relevant information beforehand.

13. A non-transitory computer readable medium storing program instructions which, when executed by one or more processors, causes a system to perform operations comprising:
acquiring information associated with an imaged field including a user,
recognizing a pose formed by a body of the user in a real space and relevant information associated with a feature of the pose, on a basis of the information, and
executing a command linked with a combination of the pose and the relevant information beforehand.
